(19) United States
(12) Patent Application Publication
(10) Pub. No.: US 2006/0160915 A1
(43) Pub. Date: Jul. 20, 2006

(54) Photocurable compositions

(76) Inventors: Andre Fuchs, Schliengen-Obereggenen (DE); Rinaldo Husler, Basel (CH); Thomas Bolle, Efringen-Kirchen (DE)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/544,509

(22) PCT Filed: Feb. 9, 2004
(86) PCT No.: PCT/EP04/50103

§ 371 Date: Aug. 3, 2005

(30) Foreign Application Priority Data
Feb. 20, 2003 (EP) 03405109.4

(51) Int. Cl. C08F 2/50

(52) U.S. Cl. 522/6

(57) ABSTRACT

Benzophenone derivatives of formula I 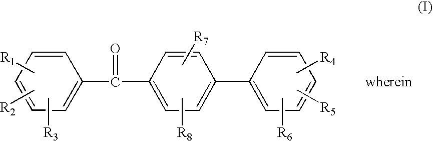
R₁, R₂ and R₃ are each independently of the others hydrogen or C₁-C₄alkyl, cyclopentyl or cyclohexyl;
R₄, R₅ and R₆ are each independently of the others hydrogen, C₁-C₄alkyl, cyclopentyl or cyclohexyl;
R₇ and R₈ are each independently of the other hydrogen, C₁-C₄alkyl, cyclopentyl or cyclohexyl; with the provisos that
(i) at least one radical R₁, R₂, R₃, R₄, R₅, R₆, R₇, R₈ is other than hydrogen;
(ii) when all radicals R₄, R₅ , R₆, R₇ and R₈ are hydrogen and only one radical R₁, R₂, R₃ is C₁-C₄alkyl, that radical must be in the meta-position of the phenyl ring; and
(iii) when all radicals R₁, R₂, R₃, R₇ and R₈ are hydrogen and two of the radicals R₄, R₅ and R₆ are hydrogen and the remaining radical R₄, R₅ or R₆ is C₁-C₄alkyl, that alkyl radical is not bonded in the para-position on the phenyl ring; are found to be especially suitable in photocurable compositions in respect of solubility, reactivity and a low level of yellowing.

The Invention relates to photopolymerizable compositions comprising specific benzophenone derivatives as photohardeners.

Benzophenones and benzophenone derivatives are described in the art. Their use as photohardeners is also known.

For example, WO 98/28340, EP 209 831 and EP 386 650 describe the use of alkyl-substituted benzophenone derivatives in photocurable formulations.

U.S. Pat. No. 5,476,970 discloses a preparation process for aryl ketones. Phenyl-substituted benzophenones are known as photohardeners from EP 51 329.

In J. Org. Chem, 1989, 54, 4706-4708, H. Yamataka et al. describe the reaction of benzophenones with phenyllithium compounds. S. Kumar et al. in Indian Journal of Chemistry, Vol. 22B, 1983,17-22, describe the Friedel-Crafts aroylation of benzene and biphenyl.

J. Amer. Chem. Soc. 68, (1946), 343 describes the preparation of mesityl p-phenylphenyl ketone and J. Amer. Chem. Soc. 54, (1932), 1124-1133 discloses the preparation of 2-methyl-4′-phenyl-benzophenone.

There is a need in the art for reactive, technically readily obtainable, readily soluble photoinitiators that give rise to only low levels of yellowing and odour. The Invention relates to photocurable compositions comprising
(a) at least one ethylenically unsaturated photopolymerisable compound and
(b) as photoinitiator at least one compound of formula I 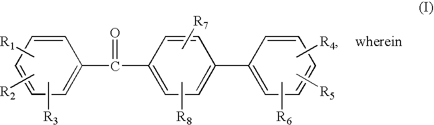
R₁, R₂ and R₃ are each independently of the others hydrogen or C₁-C₄alkyl, cyclopentyl or cyclohexyl;
R₄, R₅ and R₆ are each independently of the others hydrogen, C₁-C₄alkyl, cyclopentyl or cyclohexyl;
R₇ and R₈ are each independently of the other hydrogen, C₁-C₄alkyl, cyclopentyl or cyclohexyl;
   with the provisos that
(i) at least one radical R₁, R₂, R₃, R₄, R₅, R₆, R₇, R₈ is other than hydrogen;
(ii) when all radicals R₄, R₅ R₆, R₇ and R₈ are hydrogen and only one radical R₁, R₂, R₃ is C₁-C₄alkyl, that radical must be in the meta-position of the phenyl ring; and
(iii) when all radicals R₁, R₂, R₃, R₇ and R₈ are hydrogen and two of the radicals R₄, R₅ and R₆ are hydrogen and the remaining radical R₄, R₅ or R₆ is C₁-C₄alkyl, that alkyl radical is not bonded in the para-position on the phenyl ring.

The benzophenone derivatives used in the compounds according to the invention are found to be especially suitable in respect of solubility, reactivity, and a low level of yellowing of the cured formulation.

C₁-C₄Alkyl is linear or branched and is, for example, C₂-C₄alkyl. Examples are methyl, ethyl, propyl, isopropyl, n-butyl, sec-butyl, isobutyl and tert-butyl.

For example, R₁, R₂. R₃, R₄, R₅, R₆, R₇ and R₈ as alkyl are preferably methyl.

The preparation of benzophenone and benzophenone derivatives will be familiar to the person skilled in the art and is frequently described in the literature.

The compounds are usually prepared by reaction of an aromatic hydrocarbon with a corresponding aromatic carboxylic acid halide in the presence of a catalyst, for example AlCl₃.

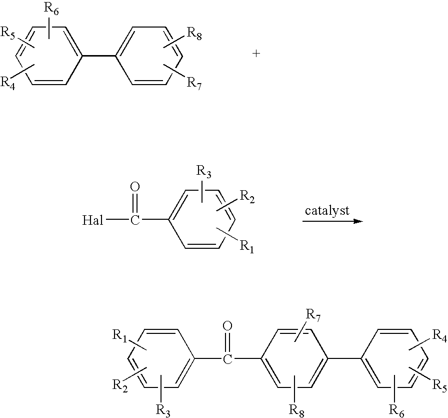

The radicals R₁—R₈ are as defined above; Hal is halide and is, for example, Cl or Br, preferably Cl.

The reaction is advantageously carried out in a solvent.

Suitable solvents are any solvents that are inert under the given reaction conditions, for example ethylene chloride, trichloroethylene, methylene chloride, tetrachloroethane, chlorobenzene, bromobenzene, dichlorobenzene, carbon disulfide, nitromethane, nitroethane, nitropropane and nitrobenzene. Methylene chloride is preferred.

The known Friedel-Crafts catalysts are suitable, e.g. aluminium chloride, aluminium bromide, zinc chloride, tin chloride, iron(III) chloride, bismuth chloride and boron trifluoride. Aluminium chloride is preferred.

For example, U.S. Pat. No. 5,476,970 discloses a preparation process for aryl ketones, inter alia benzophenone derivatives, wherein an aromatic hydrocarbon, for example benzene, is reacted with an aromatic carboxylic acid chloride in the presence of iron(III) chloride as catalyst.

The reaction temperature is from −20° C. to 20° C., preferably from 0° C. to 10° C., especially from 0° C. to 5° C.

In the present Friedel-Crafts reaction, usually the aromatic compound and the catalyst are used as initial charge and the acid halide is added thereto, as described by Merck in German Offenlegungsschrift DE 30 08 411 A1 (1980).

It is also possible, however, to use the aromatic compound and the acid halide as initial charge and to add the catalyst thereto. Another possibility is to use the add halide and the catalyst as initial charge and to add the aromatic compound thereto. One or other of the methods may prove more advantageous, depending upon which compounds are being prepared.

The acid halide and the catalyst are usually added in slight excess, for example a 5-10% excess of the acid halide and a 10-20% excess of the catalyst.

Such reactions are known to the person skilled in the art and are described in numerous standard works of chemistry, e.g. by George A. Olah, Friedel-Crafts and Related Reactions, III. Acylation and Related Reactions, Part 1, 1964, Interscience Publishers, Wiley & Sons, especially pages 2-5.

A further possible method of preparing the compounds according to the invention comprises the reaction of the corresponding biphenylylcarboxylic acid halides with a substituted benzene:

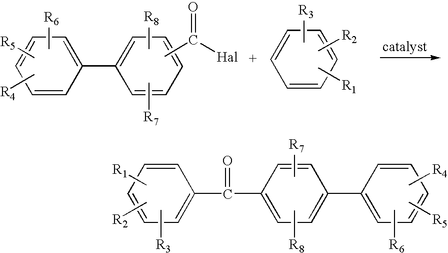

The radicals R₁-R₈ are as defined above; Hal is halide and is, for example, Cl or Br, preferably Cl.

The reaction is advantageously carried out in a solvent. Suitable solvents are, for example, those mentioned above, but in this case the use of methylene chloride or chlorobenzene is preferred. The Friedel-Crafts catalysts described above are also used as catalysts for this reaction. The reaction temperatures and other reaction conditions also correspond to those mentioned above.

For the preparation of compounds of formula I wherein the phenyl ring having the radicals R₁-R₃ is to contain a substituent in the meta-position it is necessary to use the first preparation method described, that it to say a correspondingly substituted (or unsubstituted) biphenyl must be reacted with an acid halide, preferably the chloride, meta-substituted on the aromatic compound.

The preparation of the starting materials will be known to the person skilled in the art and suitable methods are disclosed in the literature. Many of the starting materials are also commercially available.

Interesting photocurable compositions are especially those wherein in the compounds of formula (I)
R₁, R₂ and R₃ are each independently of the others C₁-₄alkyl, especially methyl; and R₄, R₅, R₆, R₇ and R₈ are hydrogen.

Further interesting photocurable compositions are those wherein in the compounds of formula (I)
R₁ is methyl and is bonded in the 3-position of the phenyl ring; and
R₂, R₃, R₄ R₅, R₆, R₇ and R₈ are hydrogen; or
R₁, R₂ and R₃ are methyl and are bonded in the 2-, 4- and 6-positions of the phenyl ring; and
R₄, R₅, R₆, R₇ and R₈ are hydrogen.

Preference is given to compositions comprising compounds of formula I wherein R₁, R₂ and R₃ are each independently of the others hydrogen or C₁-C₄alkyl.

Further interesting compositions are those comprising compounds of formula I wherein R₄. R₅ and R₆ are each independently of the others hydrogen or C₁-C₄alkyl, especially hydrogen.

Special mention should be made of compositions comprising compounds of formula I wherein R₇ and R₈ are each independently of the other hydrogen or C₁-C₄alkyl, especially hydrogen.

Special preference is given to compositions comprising compounds of formula I wherein R₁ is C₁-C₄alkyl; and R₂, R₃, R₄, R₅, R₆, R₇ and R₈ are hydrogen.

Interesting compositions comprising compounds of formula I are those wherein R₁ is C₁-C₄alkyl and is bonded in the meta-position of the phenyl ring; and R_{2,} R₃, R₄, R₅, R₆, R₇ and R₈ are hydrogen.

Preference is given to compositions comprising compounds wherein at least one radical R₁, R₂ or R₃ is other than hydrogen. Special preference is given to compositions comprising compounds wherein two of the radicals R₁, R₂ and R₃ are hydrogen and one radical is C₁-C₄alkyl.

Of interest are compositions comprising compounds of formula I wherein at least one of the radicals R₁, R₂ and R₃ is C₁-C₄alkyl, cyclopentyl or cyclohexyl, especially C₁-C₄alkyl, and is bonded in the meta-position of the phenyl ring.

Also preferred are compositions comprising compounds of formula I wherein R₂, R₃, R₄, R₅, R₆, R₇ and R₈ are hydrogen.

Special preference is given to the use of 3-methyl4′-phenyl-benzophenone and 2,4,6-tri-methyl4′-phenyl-benzophenone in the photocurable compositions according to the invention.

Some of the benzophenone derivatives of formula (I) used in the above-mentioned compositions are novel and the invention relates likewise thereto.

Especially interesting are compounds of formula Ia 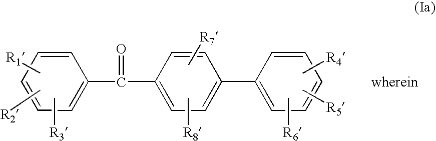
R₁′, R₂′ and R₃′ are each independently of the others hydrogen or C₂-C₄alkyl, cyclopentyl or cyclohexyl;
R₄′, R₅′ and R₆′ are each independently of the others hydrogen, C₂-C₄alkyl, cyclopentyl or cyclohexyl;
R₇′ and R₈′ are each independently of the other hydrogen, C₂-C₄alkyl, cyclopentyl or cyclohexyl;
   with the provisos that
(iv) at least one radical R₁′, R₂′, R₃′, R₄′, R₅′, R₆′, R₇′, R₈′ is other than hydrogen; and
(v) pert-butylphenyl-biphenylyl ketone is excluded.

The definition of C₂-C₄alkyl for R₁′, R₂′, R₃′, R₄′, R₅′, R₆′, R₇′ and R₈′ is as indicated above for R₁, R₂, R₃, R₄, R₅, R₆, R₇ and R₈, with the corresponding number of carbon atoms.

The term “and/or” in the context of the present Application means that not only one of the defined alternatives (substituents) may be present but several different defined alternatives (substituents) may be present together, that is to say mixtures of different alternatives (substituents) may be present.

The term “at least one” is intended to indicate “one or more than one”, e.g. one or two or three, preferably one or two.

The unsaturated compounds (a) may contain one or more olefinic double bonds. They may be of low molecular weight (monomeric) or higher molecular weight (oligomeric). Examples of monomers having a double bond are alkyl and hydroxyalkyl acrylates and methacrylates, e.g. methyl, ethyl, butyl, 2-ethylhexyl and 2-hydroxyethyl acrylate, isobornyl acrylate and methyl and ethyl methacrylate. Also of interest are resins modified with silicon or fluorine, e.g. silicone acrylates. Further examples are acrylonitrile, acrylamide, methacrylamide, N-substituted (meth)acrylamides, vinyl esters, such as vinyl acetate, vinyl ethers, such as isobutyl vinyl ether, styrene, alkyl- and halo-styrenes, N-vinylpyrrolidone, vinyl chloride and vinylidene chloride.

Examples of monomers having several double bonds are: ethylene glycol diacrylate, 1,6-hexanediol diacrylate, propylene glycol diacrylate, dipropylene glycol diacrylate, tripropylene glycol diacrylate, neopentyl glycol diacrylate, hexamethylene glycol diacrylate and bisphenol-A diacrylate, 4,4′-bis(2-acryloyloxyethoxy)diphenylpropane, trimethylolpropane triacrylate, pentaerythritol triacrylate and pentaerythritol tetraacrylate, vinyl acrylate, divinylbenzene, divinyl succinate, diallyl phthalate, triallyl phosphate, triallyl. Isocyanurate, tris(hydroxyethyl)isocyanurate triacrylate and tris(2-acryloylethyl)isocyanurate.

It is also possible in radiation-curable systems to use acrylic esters of alkoxylated polyols, for example glycerol ethoxylate triacrylate, glycerol propoxylate triacrylate, trimethylolpropaneethoxylate triacrylate, trimethylolpropanepropoxylate triacrylate, pentaerythritol ethoxylate tetraacrylate, pentaerythritol propoxylate triacrylate, pentaerythritol propoxylate tetraacrylate, neopentyl glycol ethoxylate diacrylate or neopentyl glycol propoxylate diacrylate. The degree of alkoxylation of the polyols used may vary.

Examples of higher molecular weight (oligomeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. In particular, combinations of vinyl-ether-group-carrying oligomers and polymers, as described in WO 90/01512, are very suitable, but copolymers of monomers functionalised with maleic acid and vinyl ether also come into consideration. Such unsaturated oligomers can also be termed prepolymers.

Especially suitable are, for example, esters of ethylenically unsaturated carboxylic acids and polyols or polyepoxides, and polymers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, itaconic acid, cinnamic acid and unsaturated fatty acids such as linolenic acid or oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic add hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, di-pentaerythritol and sorbitol.

The polyols may have been partially or fully esterified by one or by different unsaturated carboxylic acid(s), it being possible for the free hydroxyl groups in partial esters to have been modified, for example etherified, or esterified by other carboxylic acids.

Examples of esters are: trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diltaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable as component (a) are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N-[(β-hydroxyethoxy)ethyl]-acrylamide.

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene, hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl(meth)acrylates.

Suitable components (a) are also acrylates that have been modified by reaction with primary or secondary amines, as described e.g. In U.S. Pat. No. 3,844,916, in EP 280222, in U.S. Pat. No. 5,482,649 or in U.S. Pat. No. 5,734,002. Such amine-modified acrylates are also known as aminoacrylates. Suitable compounds are widely available commercially. Aminoacrylates are obtainable e.g. from UCB Chemicals under the name ^{RTM}EBECRYL 80, ^{RTM}EBECRYL 81, ^{RTM}EBECRYL 83, ^{RTM}EBECRYL 7100, from BASF under the name ^{RTM}Laromer PO 83F, ^{RTM}Laromer PO 84F, ^{RTM}Laromer PO 94F, from Cognis under the name ^{RTM}PHOTOMER 4775 F, ^{RTM}PHOTOMER 4967 F or from Cray Valley under e.g. the name ^{RTM}CN501, ^{RTM}CN503, ^{RTM}CN550, ^{RTM}CN383, ^{RTM}CN384.

The photopolymerisable compounds can be used on their own or in any desired mixtures. Preferably mixtures of polyol(meth)acrylates are used.

Binders may also be added to the compositions according to the invention, this being particularly advantageous when the photopolymerisable compounds are liquid or viscous substances. The amount of binder may be, for example, from 5 to 95% by weight, preferably from 10 to 90% by weight and especially from 40 to 90% by weight, based on total solids. The choice of binder is made in accordance with the field of use and the properties required therefor, such as developability in aqueous and organic solvent systems, adhesion to substrates and sensitivity to oxygen.

Suitable binders are, for example, polymers having a molecular weight of approximately from 5000 to 2 000 000, preferably from 10 000 to 1 000 000. Examples are: homo- and co-polymers of acrylates and methacrylates, e.g. methyl methacrylate/ethyl acrylate/methacrylic acid copolymers, poly(methacrylic acid alkyl esters), poly(acrylic acid alkyl esters); cellulose esters and ethers, such as cellulose acetate, cellulose acetate butyrate, methylcellulose, ethylcellulose; polyvinylbutyral, polyvinylformal, cyclised rubber, polyethers such as polyethylene oxide, polypropylene oxide, polytetrahydrofuran; polystyrene, polycarbonate, polyurethane, chlorinated polyolefins, polyvinyl chloride, copolymers of vinyl chloride/vinylidene chloride, copolymers of vinylidene chloride with acrylonitrile, methyl methacrylate and vinyl acetate, polyvinyl acetate, copoly(ethylene/vinyl acetate), polymers such as polycaprolactam and poly(hexamethylene adipamide), polyesters such as poly(ethylene glycol terephthalate) and poly(hexamethylene glycol succinate).

The unsaturated compounds can also be used in admixture with non-photopolymerisable film-forming components. These may be, for example, physically drying polymers or solutions thereof in organic solvents, for example nitrocellulose or cellulose acetobutyrate, but they may also be chemically or thermally curable resins, for example polyisocyanates, polyepoxides or melamine resins. The concomitant use of thermally curable resins is important for use in so-called hybrid systems, which are photopolymerised in a first step and crosslinked by thermal after-treatment in a second step.

The compounds of formula I and Ia can also be used as initiators for curing oxidatively drying systems, as described, for example, in Lehrbuch der Lacke und Beschichtungen Vol. III, 296-328, Verlag W. A. Colomb in der Heenemann GmbH, Berlin-Oberschwandorf (1976).

The photopolymerisable compositions according to the invention may comprise, in addition to component (b), also other photoinitiators (c) and/or other additives (d).

Examples of other additives (d) are thermal inhibitors, which are intended to prevent premature polymerisation, e.g. hydroquinone, hydroquinone derivatives, p-methoxyphenol, β-naphthol or sterically hindered phenols, e.g. 2,6-di(tert-butyl)-p-cresol. In order to increase dark storage stability it is possible to use, for example, copper compounds, such as copper naphthenate, stearate or octanoate, phosphorus compounds, for example triphenylphosphine, tributylphosphine, triethyl phosphite, triphenyl phosphite or triphenyl phosphite, quaternary ammonium compounds, e.g. tetramethylammonium chloride or trimethylbenzyl-ammonium chloride, or hydroxylamine derivatives, e.g. N,N-diethylhydroxylamine. For the purpose of excluding atmospheric oxygen during polymerisation it is possible to add paraffin or similar wax-like substances which, being insoluble in the polymer, migrate to the surface at the beginning of the polymerisation and form a transparent surface layer which prevents air from entering. Equally possible is the application of a layer that is impermeable to oxygen. As light stabilisers it is possible to add UV absorbers, e.g. those of the hydroxyphenylbenzotriazole, hydroxyphenylbenzophenone, oxalic acid amide or hydroxy-phenyl-s-triazine type. Such compounds can be used on their own or in the form of mixtures, with or without the use of sterically hindered amines (HALS).

Examples of such UV absorbers and light stabilisers are 1,2-(2′-Hydroxyphenyl)-benzotriazoles. e.g. 2-(2′-hydroxy-5′-methylphenyl)-benzotriazole, 2-(3′,5′-di-tert-butyl-2′-hydroxyphenyl)-benzotriazole, 2-(5′-tert-butyl-2′-hydroxyphenyl)-benzotriazole, 2-2′-hydroxy-5′-1,1,3,3-tetramethylbutyl)-phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-3′-sec-butyl-5′-tert-butyl-2′-hydroxyphenyl)-benzotriazole, 2-2′-hydroxy-4′-octyloxyphenyl)-benzotriazole, 2-(3′,5′-di-tert-amyl-2′-hydroxyphenyl)-benzotriazole, 2-3′,5′-bis(α,α-dimethylbenzyl)-2′-hydroxyphenyl)benzotriazole, a mixture of 2-(3′-tert-butyl-2′-hydroxy-5′-(2-octyloxycarbonylethyl)-phenyl)-chlorobenzotriazole, 2-(3′-tert-butyl-5′-[2-(2-ethylhexyloxy)-carbonylethyl]-2′-hydroxyphenyl)-5chlorobenzotriazole, 2-(3′-tert-butyl-2′-hydroxy-5′-(2-methoxycarbonylethyl)-phenyl)-5-chlorobenzotriazole, 2-(3′-tert-butyl-2′-hydroxy-5′-2-methoxycarbonylethyl)-phenyl)-benzotriazole, 2-(3′-tert-butyl-2′-hydroxy-5′-(2-octyloxycarbonylethyl)-phenyl)-benzotriazole, 2-(3′-tert-butyl-5′-[2-(2-ethylhexyloxy)-carbonylethyl]-2′-hydroxyphenyl)-benzotriazole, 2-(3′-dodecyl-2′-hydroxy-5′-methylphenyl)-benzotriazole and 2-(3′-tert-butyl-2′-hydroxy-5′-(2-isooctyloxycarbonylethyl)-phenyl-benzotriazole, 2,2′-methylene-bis[4-(1,3,3-tetramethylbutyl)-6-benzotriazol-2-yl-phenol]; the transesterification product of 2-[3′-tert-butyl-5′-(2-methoxycarbonylethyl)-2′-hydroxyphenyl]-benzotriazole with polyethylene glycol 300; [R—CH₂CH₂—COO(CH₂)₃]₂— wherein R=3′-tert-butyl-4′-hydroxy-5′-2H-benzotriazol-2-yl-phenyl.

2.2-Hydroxybenzophenones, e.g. a 4-hydroxy, 4-methoxy, 4-octyloxy, 4-decyloxy, 4-do-decyloxy, 4-benzyloxy, 4,2′,4′-trihydroxy or 2′-hydroxy-4,4′-dimethoxy derivative.

3. Esters of unsubstituted or substituted benzoic acids. e.g. 4-tert-butyl-phenyl salicylate, phenyl salicylate, octylphenyl salicylate, dibenzoylresorcinol, bis(4-tert-butylbenzoyl)resorcinol, benzoylresorcinol, 3,5-di-tert-butyl-4-hydroxybenzoic acid 2,4-di-tert-butylphenyl ester, 3,5di-tert-butyl-4-hydroxybenzoic acid hexadecyl ester, 3,5di-tert-butyl-4-hydroxybenzoic acid octadecyl ester and 3,5-di-tert-butyl-4-hydroxybenzoic acid 2-methyl-4,6-tert-butyl-phenyl ester.

4. Acrylates, e.g. α-cyano-β,β-diphenylacrylic acid ethyl ester or isooctyl ester, α-methoxy-carbonylcinnamic acid methyl ester, α-cyano-β-methyl-p-methoxycinnamic acid methyl ester or butyl ester, α-methoxycarbonyl-p-methoxycinnamic acid methyl ester and N-(β-methoxy-carbonyl-β-cyanovinyl)-2-methyl-indoline.

5. Sterically hindered amines. e.g. bis(2,2,6,6-tetramethylpiperidyl) sebacate, bis(2,2,6,6-tetramethylpiperidyl)succinate, bis(1,2,2,6,6-pentamethylpiperidyl)sebacate, n-butyl-3,5-di-tert-butyl-4-hydroxybenzyl-malonic acid bis(1,2,2,6,6-pentamethylpiperidyl) ester, the condensation product of 1-hydroxyethyl-2,2,6,6-tetramethyl-4-hydroxypiperidine and succinic acid, the condensation product of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl)nitrlotriacetate, tetrakis(2,2,6,6-tetramethyl-4-piperidyl) 1,2,3,4-butanetetraoate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl) 2-n-butyl-2-(2-hydroxy-3,5-di-tert-butylbenzyl)malonate, 3-n-octyl-7,7,9,9-tetramethyl-1,3,8-tri-azaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, the condensation product of N,N′-bis-(2,2,6,6-tetramethyl-4-piperidyl)hexamethylenediamine and 4-morpholino-2,6-dichloro-1,3,5-triazine, the condensation product of 2-chloro-4,6-di(4-n-butylamino-2,2,6,6-tetramethylpiperidyl)-1,3,5-triazine and 1,2-bis(3-aminopropylamino)ethane, the condensation product of 2-chloro-4,6-di(4-n-butylamino-1,2,2,6,6-pentamethylpiperidyl)-1,3,5-triazine and 1,2-bis-(3-aminopropylamino)ethane, 8-acetyl-3-dodecyl-7,7,9,9-tetramethyl-1,3,8-triazaspiro[4.5]-decane-2,4-dione, 3-dodecyl-1-(2,2,6,6-tetramethyl4 piperidyl)-pyrrolidine-2,5-dione, 3-dodecyl-1-(,2,2.6,6-pentamethyl-4-piperidyl)-pyrrolidine-2,5-dione, 2,4-bis[N-(1-cyclohexyloxy-2,2,6-6-tetramethylpiperidin-4-yl)-n-butyl-amino]-6-(2-hydroxyethyl)amino-1,3,5-triazine and the condensation product of 2,4-bis[1-cyclohexyloxy-2,2,6,6-tetramethylpiperidin)-4-yl)-butylamino]-6-chloro-s-triazine and N,N′-bis(3-aminopropyl)ethylenediamine.

6. Oxalic acid diamides. e.g. 4,4′-dioctyloxy-oxanilide, 2,2′-diethoxy-oxanilide, 2,2′-dioctyloxy-5,5′-di-tert-butyl oxanilide, 2,2′-didodecyloxy,5,5′-di-tert-butyl oxanilide, 2-ethoxy-2′-ethyl oxanilide, N,N′-bis(3-dimethylaminopropyl)oxalamide, 2-ethoxy-5-tert-butyl-2′-ethyl oxanilide and a mixture thereof with 2-ethoxy-2′-ethyl-5,4′-di-tert-butyl oxanilide, and mixtures of o- and p-methoxy- and of o- and p-ethoxy-disubstituted oxanilides.

7. 2(2-Hydroxyphenyl)-1,3,5-triazines. e.g. 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxy-phenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecylphenyl)-4,6-bis(2,4-dimethylphenyl)-1,3,5-triazine, 2-[2-hydroxy-4-(2-hydroxy-3-butyloxy-propyloxy)-phenyl]-4,6-bis(2,4-dimethylphenyl)-1,3,5-triazine, 2-[2-hydroxy-4-(2-hydroxy-3-octyloxy-propyloxy)-phenyl]-4,6-bis(2,4-dimethylphenyl)-1,3,5-triazine and 2-[4-dodecyloxy/tridecyloxy-(2-hydroxypropyl)oxy-2-hydroxy-phenyl]-4,6-bis(2,4-dimethylphenyl)-1,3,5-triazine.

8. Phosphites and phosphonites. e.g. triphenyl phosphite, diphenylalkyl phosphites, phenyl-dialkyl phosphites, tris(nonylphenyl) phosphite, trilauryl phosphite, trioctadecyl phosphite, distearyl-pentaerythritol diphosphite, tris(2,4-di-tert-butylphenyl) phosphite, diisodecylpentaerythritol diphosphite, bis(2,4-di-tert-butylphenyl)pentaerythritol diphosphite, bis(2,6-di-tert-butyl-4-methylphenyl)pentaerythritol diphosphite, bis-isodecyloxy-pentaerythritol diphosphite, bis(2,4-di-tert-butyl-6-methylphenyl)pentaerythritol diphosphite, bis(2,4,6-tri-tert-butylphenyl)pentaerythritol diphosphite, tristearyl sorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo-[d,g]-1,3,2-dioxaphosphocine, bis(2,4-di-tert-butyl-6-methylphenyl)methyl phosphite and bis(2,4-tert-butyl-6-methylphenyl)ethyl phosphite.

Examples of UV absorbers and light stabilisers suitable as components (d) also include “Krypto-UVA” as described e.g. In EP 180 548. It is also possible to use latent UV absorbers, as described e.g. by Hida et al in RadTech Asia 97, 1997, page 212.

Additives customary in the art, e.g. antistatics, flow improvers and adhesion enhancers, can also be used. Further customary additives (d) are—depending upon the intended use—optical brighteners, fillers, pigments, white and coloured pigments, dyes, antistatics and wetting agents.

A large number of amines can be added as further additives (d) to accelerate photopolymerisation, e.g. triethanolamine, N-methyl-diethanolamine, p-dimethylaminobenzoic acid ethyl ester or Michler's ketone and corresponding derivatives. Amides and other amine derivatives are also known as accelerators. The amino-modified acrylates (aminoacrylates) already mentioned above (as component (a)) can also act as accelerators in this context, as can also acrylated polyethylene glycol derivatives as described above.

Of special interest are the amine synergist compounds known to the person skilled in the art, for example Michler's ketone and corresponding derivatives,

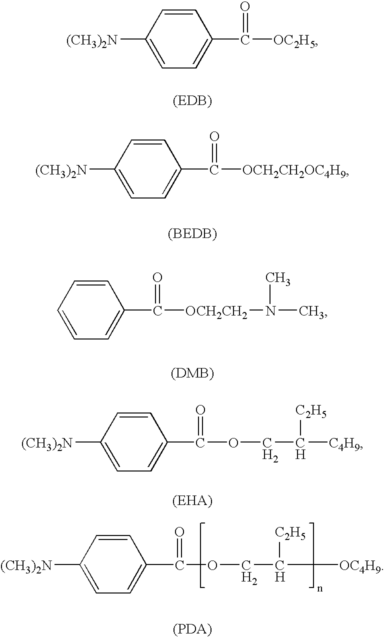

Also of special interest, therefore, are compositions comprising

(a) at least one ethylenically unsaturated photopolymerisable compound and

(b) as photoinitiator at least one compound of formula I as described above, and at least one amine synergist, aminoacrylate or/and aliphatic amine compound.

Amines suitable for use as oxygen capture agents are, for example, substituted N,N-dialkyl-anilines, as described in EP 339 841. Further accelerators, coinitiators and autooxidisers are thiols, thioethers, disulfides and phosphines, as described e.g. in EP 438 123 and GB 2180 358.

It is also possible for chain-transfer reagents customary in the art to be added to the compositions according to the invention. Examples are mercaptans, amines and benzothiazole.

Furthermore, photopolymerisation can be accelerated by the addition of photosensitisers as further additives (d) which shift or broaden the spectral sensitivity. Such photosensitisers are especially aromatic carbonyl compounds, for example further benzophenone derivatives or benzophenone, thioxanthone derivatives, especially isopropylthioxanthone, anthraquinone derivatives and 3-acylcoumarin derivatives, terphenyls, styrylketones, as well as 3-(aroylmethylene)-thiazolines, camphorquinone, and also eosin, rhodamine and erythrosine dyes.

The amines mentioned above, for example, can also come into consideration as photosensitisers.

Further examples of such photosensitisers are

1. Thioaxanthones

Thioxanthone, 2-isopropylthioxanthone, 3-isopropylthioxanthone, 2-chlorothioxanthone, 2-dodecylthioxanthone, 1-chloro-4-propoxythioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl)-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholino-ethyl)thioxanthone, 2-methyl-6-dimethoxymethyl-thioxanthone, 2-methyl-6-(1,1-dimethoxy-benzyl)-thioxanthone, 2-morpholinomethylthioxanthone, 2-methyl-6-morpholinomethyl-thioxanthone, N-allylthioxanthone-3,4-dicarboximide, N-octylthioxanthone-3,4-dicarboximide, N-(1,1,3,3-tetramethylbutyl)-thioxanthone3,4-dicarboximide, 1-phenoxythioxanthone, 6ethoxycarbonyl-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride;

2. 3-Acylcoumarins

3-Benzoylcoumarin, 3-benzoyl-7-methoxycoumarin, 3-benzoyl-5,7-di(propoxy)coumarin, 3-benzoyl-6,8-dichlorocoumarin, 3-benzoyl-6-chlorocoumarin, 3,3′-carbonyl-bis[5,7-di(pro-poxy)coumarin], 3,3′-carbonyl-bis(7-methoxycoumarin), 3,3′-carbonyl-bis(7-diethylaminocoumarin), 3-isobutyroylcoumarin, 3-benzoyl-5,7-dimethoxycoumarin, 3-benzoyl-5,7-di-ethoxycoumarin, 3-benzoyl-5,7-dibutoxycoumarin, 3benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-dimethoxy-3-(1-naphthoyl)-coumarin, 3-benzoylbenzo[f]coumarin, 7-diethylamino-3-thienoylcoumarin, 3-(4-cyanobenzoyl)-5,7-dimethoxycoumarin;

3. 3-(Aroylmethylene)-thiazolines

3-Methyl-2benzoylmethylene-β-naphthothiazoline, 3-methyl-2-benzoylmethylene-benzothiazoline, 3-ethyl-2-propionylmethylene-β-naphthothiazoline;

4. Other carbonyl Compounds

Acetophenone, 3-methoxyacetophenone, 4-phenylacetophenone, benzil, 2-acetylnaphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethylaminobenzylidene) ketones, such as 2-(4-dimethylamino-benzylidene)-indan-1-one or 3-(4-dimethylamino-phenyl-1-indan-5-yl-propenone, 3-phenylthiophthalimide, N-methyl-3,5-di(ethylthio)phthalimide.

The curing operation can be assisted especially by pigmented compositions (pigmented e.g. with titanium dioxide), and also by the addition as additional additive (d) of a component that forms free radicals under thermal conditions, e.g. an azo compound, such as 2,2′-azobis(4-methoxy-2,4-dimethylvaleronitrile), a triazene, a diazosulfide, pentazadiene or a peroxy compound, for example hydroperoxide or peroxycarbonate, e.g. tert-butyl hydroperoxide, as described e.g. in EP 245 639.

The compositions according to the invention may also comprise as further additives (d) a photo-reducible dye, e.g. a xanthene, benzoxanthene, benzothioxanthene, thiazine, pyronine, porphyrin or acridine dye, and/or a trihalomethyl compound cleavable by radiation. Similar compositions are described, for example, in EP 445 624.

For curing thick and pigmented coatings, for example the addition of glass microspheres or pulverised glass fibres, as described e.g. in U.S. Pat. No. 5,013,768, is suitable.

The formulations may also comprise dyes and/or white or coloured pigments. Inorganic or organic pigments may be used, according to the intended use. Such additives are known to the person skilled in the art, some examples being titanium dioxide pigments, e.g. of the rutile or anatase type, carbon black, zinc oxide, such as zinc white, iron oxides, such as iron oxide yellow, iron oxide red, chromium yellow, chromium green, nickel titanium yellow, ultramarine blue, cobalt blue, bismuth vanadate, cadmium yellow and cadmium red. Examples of organic pigments are mono- or bis-azo pigments, and also metal complexes thereof, phthalocyanine pigments, polycyclic pigments, for example perylene, anthraquinone, thioindigo, quinacridone or triphenylmethane pigments, and also diketo-pyrrolo-pyrrole, isoindolinone, e.g. tetrachloroisoindolinone, isoindoline, dioxazine, benzimidazolone and quinophthalone pigments.

The pigments can be used in the formulations individually or in admixture.

Depending upon the intended use, the pigments are added to the formulations in amounts customary in the art, for example in an amount of from 0.1 to 60% by weight, from 0.1 to 30% by weight or from 10 to 30% by weight, based on the total mass.

The formulations may also, for example, comprise organic dyes of an extremely wide variety of classes. Examples are azo dyes, methine dyes, anthraquinone dyes and metal complex dyes. Customary concentrations are, for example, from 0.1 to 20%, especially from 1 to 5%, based on the total mass.

Depending upon the formulation used, it is also possible to use as stabilisers compounds that neutralism acids, especially amines. Suitable systems are described, for example, in JP-A 11-199610. Examples are pyridine and derivatives thereof, N-alkyl- or N,N-dialkyl-anilines, pyrazine derivatives, pyrrole derivatives etc.

The choice of additives is governed by the field of use in question and the properties desired for that field. The above-described additives (d) are customary in the art and are accordingly used in amounts customary in the art.

The proportion of additional additives in the formulations according to the invention is, for example, from 0.01 to 10% by weight, for example from 0.05 to 5% by weight, especially from 0.1 to 5% by weight

The invention relates also to compositions comprising as component (a) at least one ethylenically unsaturated photopolymerisable compound dissolved or emulsified in water. Such aqueous radiation-curable prepolymer dispersions are commercially available in many variations and are to be understood as being dispersions consisting of water and at least one prepolymer dispersed therein. The concentration of water in such systems is, for example, from 2 to 80% by weight, especially from 30 to 60% by weight. The radiation-curable prepolymer or mixture of prepolymers is present, for example, in concentrations of from 95 to 20% by weight, especially from 70 to 40% by weight. In such compositions the sum of the percentages mentioned for water and prepolymer will be 100 in each case, the auxiliaries and additives, which will be present in varying amounts in accordance with the intended use, being in addition thereto.

The radiation-curable film-forming prepolymers, which are dispersed or in many cases dissolved in water, are mono- or poly-functional ethylenically unsaturated prepolymers that can be initiated by free radicals, which prepolymers are known per se for aqueous prepolymer dispersions and contain, for example, from 0.01 to 1.0 mol of polymerisable double bonds per 100 g of prepolymer and have an average molecular weight of, for example, at least 400, especially of from 500 to 10 000. Prepolymers having higher molecular weights may also be suitable, however, depending upon the intended use.

There are used, for example, polymerisable C—C double-bond-containing polyesters having an acid number of at most 10, polymerisable C—C double-bond-containing polyethers, hydroxyl-group-containing reaction products of a polyepoxide containing at least two epoxy groups per molecule with at least one α,β-ethylenically unsaturated carboxylic acid, polyurethane(meth)acrylates and acrylic copolymers containing α,β-ethylenically-unsaturated acrylic radicals, as described in EP 12 339. Mixtures of those prepolymers may also be used. Also suitable are the polymerisable prepolymers described in EP 33 896, which are thioether adducts of polymerisable prepolymers having an average molecular weight of at least 600, a carboxyl group content of from 0.2 to 15% and a content of from 0.01 to 0.8 mol of polymerisable C—C double bonds per 100 g of prepolymer. Other suitable aqueous dispersions based on specific (meth)acrylic acid alkyl ester polymerisation products are described in EP 41 125, and suitable water-dispersible radiation-curable prepolymers of urethane acrylates can be found in DE 2 936 039.

As further additives such radiation-curable aqueous prepolymer dispersions may also comprise the additional additives (d) described above, that is to say e.g. dispersing agents, emulsifiers, anti-oxidants, light stabilisers, dyes, pigments, fillers, e.g. talcum, gypsum, silicic acid, rutile, carbon black, zinc oxide, iron oxides, reaction accelerators, flow agents, lubricants, wetting agents, thickeners, matting agents, antifoams and other adjuvants customary in surface-coating technology. Suitable dispersing agents include water-soluble high molecular weight organic compounds having polar groups, e.g. polyvinyl alcohols, polyvinylpyrrolidone and cellulose ethers. As emulsifiers it is possible to use non-ionic and, where appropriate, also Ionic emulsifiers.

The photoinitiators of formula I and Ia can also be dispersed as such in aqueous solutions and added in that dispersed form to the mixtures being cured. When combined with suitable non-ionic or, where applicable, ionic emulsifiers, the photoinitiators can be incorporated by mixing and e.g. grinding in water, forming stable emulsions which can be used as such as photoinitiators, especially for aqueous photocurable mixtures as described above.

In certain cases it may be advantageous to use mixtures of two or more photoinitiators, e.g. mixtures with camphor quinone, benzophenone, further benzophenone derivatives, acetophenone, acetophenone derivatives, for example α-hydroxycycloalkylphenyl ketones or 2-hydroxy-2-methyl-1-phenyl-propanone, ^{RTM}ESACURE KIP (F. Lamberti), dialkoxyacetophenones, α-hydroxy- or α-amino-acetophenones, e.g. (4-methylthiobenzoyl)-1-methyl-1-morpholino-ethane, (4-morpholino-benzoyl)-1-benzyl-1-dimethylamino-propane, (4-methyl-thiobenzoyl)1-methyl-1-morpholino-ethane, (4-morpholino-benzoyl)-1-(4-methylbenzyl)-1-dimethylamino-propane, 4-aroyl-1,3-dioxolanes, benzoin alkyl ethers and benzil ketals, e.g. benzil dimethyl ketal, phenyl glyoxalates and derivatives thereof, dimeric phenyl glyoxylates, e.g. 5,5′-oxodi(ethyleneoxydicarbonylphenyl), monoacylphosphine oxides, e.g. (2,4,6-trimethylbenzoyl)-diphenyl-phosphine oxide, bisacylphosphine oxides, e.g. bis(2,6-dimethoxy-benzoyl)-(2,4,4-trimethyl-pent-1-yl)phosphine oxide, bis(2,4,6-trimethylbenzoyl)-phenyl-phosphine oxide or bis(2,4,6-trimethylbenzoyl)-(2,4-dipentyloxyphenyl)phosphine oxide, trisacylphosphine oxides, halomethyltriazines, e.g. 2-[2-(4-methoxy-phenyl)-vinyl]-4,6-bis-trichloromethyl[1,3,5]triazine, 2-(4-methoxy-phenyl)-4,6-bis-trichloromethyl[1,3,5]triazine, 2-(3,4-dimethoxy-phenyl)-4,6-bis-trichloromethyl[1,3,5]triazine, 2-methyl-4,6-bis-trichloromethyl-[1,3,5]triazine, hexaarylbisimidazole/coinitiator systems, e.g. ortho-chlorohexa-phenyl-bisimidazole in combination with 2-mercaptobenzothiazole; ferrocenium compounds or titanocenes, for example dicyclopentadienyl-bis(2,6-difluoro-3-pyrrolo-phenyl)-titanium; O-acyloxime ester compounds, as described e.g. in GB 2 339 571. It is also possible to use borate compounds as coinitiators.

When the photoinitiators are used in hybrid systems (which in this connection mean mixtures of free-radically and cationically curing systems), in addition to the free-radical hardeners there are also used cationic photoinitiators, e.g. benzoyl peroxide (other suitable peroxides are described in U.S. Pat. No. 4,950,581, column 19, lines 17-25), aromatic sulfonium, phosphonium or iodonium salts, as described e.g. in U.S. Pat. No. 4,950,581, column 18, line 60 to column 19, line 10, for example 4-isopropylphenyl4′-methylphenyliodonium hexafluorophosphate, 4-isobutylphenyl-4′-methylphenyl-iodonium hexafluorophosphate (or corresponding compounds with other anions, e.g. SbF₅, BF₄, B(pentafluorophenyl)₄), or cyclopentadienylarene-iron(II) complex salts, e.g. (η⁶-isopropylbenzene)(η⁵-cyclopentadienyl) iron(II) hexafluorophosphate or photolatent acids based on oxime esters, as described, for example, in GB 2 348 644, U.S. Pat. No. 4,450,598, U.S. Pat. No. 4,136,055, WO 00/10972 and WO 00/26219.

The invention relates also to compositions wherein the additional photoinitiators (c) are compounds of formulae III, IV, V, VI, VII, VIII or/and IX 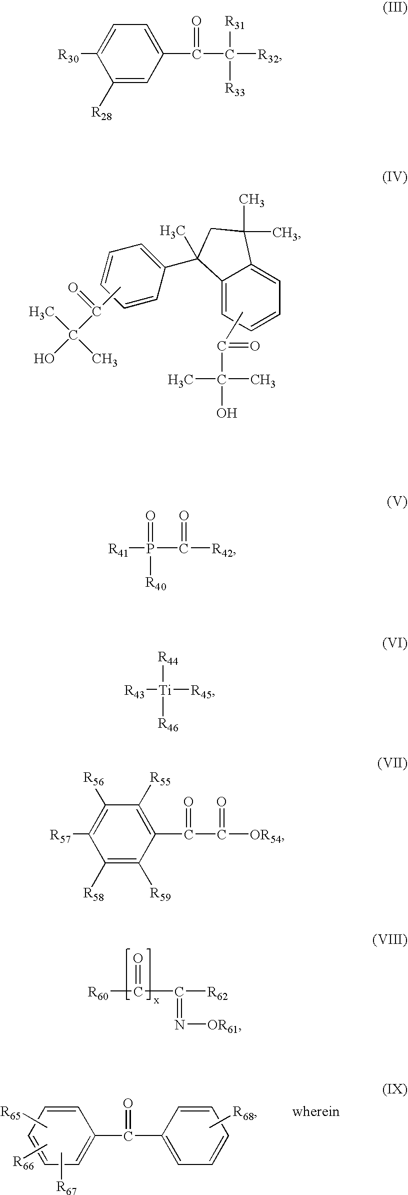
R₂₉ is hydrogen or C₁-C₆alkoxy;
R₃₀ is hydrogen, C₁-C₁₈alkyl, C₁-C₁₈alkoxy, —OCH₂CH₂—OR₄₇, morpholino, SCH₃, a group 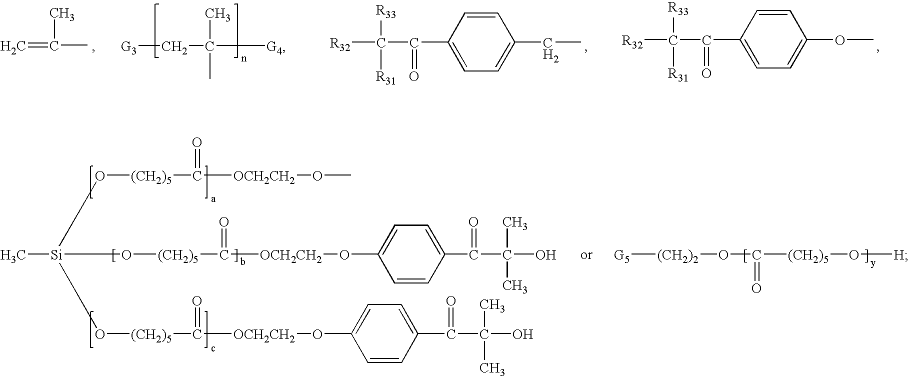
a, b and c are an average of 3;
n has a value from 2 to 10;
y is from 0 to 10;
G₃ and G₄ are each independently of the other terminal groups of the polymeric unit, especially hydrogen or CH₃;
R₃₁ is hydroxy, C₁-C₁₆alkoxy, morpholino, dimethylamino or —O(CH₂CH₂O)ₘ—C₁-C₆alkyl;
R₃₂ and R₃₃ are each independently of the other hydrogen, C₁-C₆alkyl, C₁-C₁₆alkoxy or —O(CH₂CH₂O)ₘ—C₁-C₁₆alkyl; or R₃₂ and R₃₃ are phenyl or benzyl, those radicals being unsubstituted or substituted by C₁-C₁₂alkyl; or R₃₂ and R₃₃ together with the carbon atom to which they are bonded form a cyclohexyl ring;
m is a number from 1 to 20;
but R₃₁, R₃₂ and R₃₃ are not all simultaneously C₁-C₁₆alkoxy or —O(CH₂CH₂O)ₘ—C₁-C₆alkyl;
R₄₇ is hydrogen, 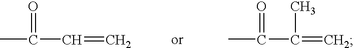
R₃₄, R₃₆, R₃₇ and R₃₈ are each independently of the others hydrogen or methyl;
R₃₅ and R₃₉ are hydrogen, methyl or phenylthio, the phenyl ring of the phenylthio radical being unsubstituted or substituted in the 4-, 2-, 2,4- or 2,4,6-position(s) by C₁-C₄alkyl;
R₄₀ and R₄₁ are each independently of the other C₁-C₂₀alkyl, cyclohexyl, cyclopentyl, phenyl, naphthyl or biphenylyl, those radicals being unsubstituted or substituted by halogen, C₁-C₁₂alkyl, C₁-C₁₂alkoxy, C₁-C₁₂alkylthio or NR₅₂R₅₃, or R₄₀ and R₄₁ are a S- or N-containing 5- or 6-membered heterocyclic ring or —(CO)R₄₂;
R₄₂ is cyclohexyl, cyclopentyl, phenyl, naphthyl or biphenylyl, those radicals being unsubstituted or substituted by halogen, C₁-C₄alkyl or/and C₁-C₄alkoxy, or R₄₂ is a S- or N-containing 5- or 6-membered heterocyclic ring;
R₄₃ and R₄₄ are each independently of the other cyclopentadienyl unsubstituted or mono-, di- or tri-substituted by C₁-C₁₆alkyl, C₁-C₁₈alkoxy, cyclopentyl, cyclohexyl or halogen;
R₄₅ and R₄₈ are each independently of the other phenyl which is substituted by fluorine atoms or CF₃ in at least one of the two positions ortho to the titanium-carbon bond and which may contain, as further substituents on the aromatic ring, polyoxaalkyl; or pyrrolinyl unsubstituted or substituted by one or two C₁-C₁₂alkyl, di(C₁-C₁₂alkyl)aminomethyl, morpholinomethyl, C₂-C₄alkenyl, methoxymethyl, ethoxymethyl, trimethylsilyl, formyl, methoxy or phenyl substituents,
or R₄₅ and R₄₆ are 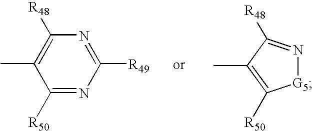
R₄₈, R₄₉ and R₅₀ are each independently of the others hydrogen, halogen, C₂-C₁₂alkenyl, C₁-C₁₂alkoxy, C₂-C₁₂alkoxy interrupted by from one to four O atoms, cyclohexyloxy, cyclopentyloxy, phenoxy, benzyloxy, or phenyl or biphenylyl each unsubstituted or substituted by C₁-C₄alkoxy, halogen, phenylthio or C₁-C₄alkylthio,
wherein R₄₈ and R₅₀ are not both simultaneously hydrogen and in the radical 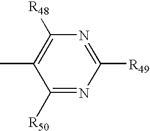
   at least one radical R₄₈ or R₅₀ is C₁-C₁₂alkoxy, C₂-C₁₂alkoxy interrupted by from one to four O atoms, cyclohexyloxy, cyclopentyloxy, phenoxy or benzyloxy;
G₅ is O, S or NR₅₁; and
R₅₁ is C₁-C₈alkyl, phenyl or cyclohexyl;
R₅₂ and R₅₃ are each independently of the other hydrogen; C₁-C₁₂alkyl which is uninterrupted or interrupted by O atoms and which is unsubstituted or substituted by OH or SH; or
R₅₂ and R₅₃ are C₁-C₁₂alkenyl, cyclopentyl, cyclohexyl, benzyl, phenyl;
R₅₄ is hydrogen, C₁-C₁₂alkyl or a group 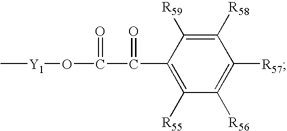
R₅₅, R₅₆, R₅₇, R₅₈ and R₅₉ are each independently of the others hydrogen; C₁-C₁₂alkyl, which is unsubstituted or substituted by OH, C₁-C₄alkoxy, phenyl, naphthyl, halogen or CN and which may be uninterrupted or interrupted by one or more O atoms; or R₅₅, R₅₆, R₅₇, R₅₈ and R₅₉ are C₁-C₄alkoxy, C₁-C₄alkylthio or NR₅₂R₅₃;
Y₁ is a divalent aliphatic or aromatic radical, especially C₁-C₁₂alkylene;
x is 0 or1;
R₆₀ is phenyl, naphthyl, or, when x is 0, 9H-carbazol-3-yl, or (9-oxo-9H-thioxanthen-2-yl), all those radicals being unsubstituted or substituted by one or more SR₆₃, OR₆₄, NR₅₂R₅₃ , halogen, C₁-C₁₂alkyl, phenyl, benzyl, —(CO)—C₁-C₄alkyl, —CO)-phenyl or —CO)-phenylene-C₁-C₄alkyl substituents;
R₆₁ is C₄-C₈cycloalkanoyl; C₁-C₁₂alkanoyl unsubstituted or substituted by one or more halogen, phenyl or CN substituents; or R₆₁ is C₄-C₆alkenoyl, with the proviso that the double bond is not conjugated with the carbonyl group; or R₆₁ is benzoyl unsubstituted or substituted by one or more C₁-C₆alkyl, halogen, CN, OR₆₄ SR₆₃ or NR₅₂R₅₃ substituents; or
R₆₁ is C₂-C₆alkoxycarbonyl, benzyloxycarbonyl; or phenoxycarbonyl unsubstituted or substituted by one or more C₁C₆alkyl or halogen substituents;
R₆₂ is hydrogen, phenyl or benzoyl, the radicals phenyl or benzoyl being unsubstituted or substituted by C₁-C₆alkyl, phenyl, halogen, OR₅₄, SR₆₃ or NR₅₂R₅₃; or R₅₂ is C₁-C₂₀alkyl or C₁-C₁₂alkoxycarbonyl, the radicals C₁-C₂₀alkyl and C₂-C₁₂alkoxycarbonyl being unsubstituted or substituted by OH and uninterrupted or interrupted by one or more O atoms; or R₆₂ is C₂-C₂₀alkanoyl, benzyl, benzyl-(CO)—, C₁-C₆alkyl-SO₂— or phenyl-SO₂—;
R₆₃ and R₆₄ are each independently of the other hydrogen or C₁-C₁₂alkyl unsubstituted or substituted by OH, SH, CN, phenyl, (CO)O—C₁-C₄alkyl, O(CO)—C₁-C₄alkyl, COOH, O(CO)-phenyl, it being possible for such unsubstituted or substituted C₁-C₁₂alkyl to be interrupted by one or more O atoms; or R₆₃ and R₆₄ are cyclohexyl, or phenyl unsubstituted or substituted by C₁-C₁₂alkyl, C₁-C₁₂alkoxy or halogen, or phenyl-C₁-C₃alkyl;
R₆₅, R₆₆ and R₆₇ are each independently of the others hydrogen, C₁-C₄alkyl, C₁-C₄haloalkyl, C₁-C₄alkoxy, chlorine or N(C₁-C₄alkyl)₂; or, for the case where R₆₇ and R₆₈ together are S, R₆₅ may also be 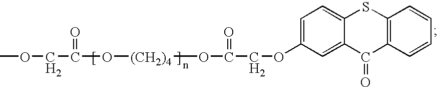
R₆₈ is hydrogen, C₁-C₄alkyl, C₁-C₄haloalkyl, phenyl, N(C₁-C₄alkyl)₂, COOCH₃, 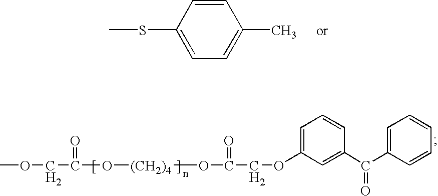
   or R₆₈ and R₆₇ together are —S—.

C₁-C₂₀Alkyl is linear or branched and is, for example, C₁-C₁₈—, C₁-C₁₂—, C₁-C₈—, C₁-C₈— or C₁-C₄-alkyl. Examples are methyl, ethyl, propyl, isopropyl, n-butyl, sec-butyl, isobutyl, tert-butyl, pentyl, hexyl, heptyl, 2,4,4-trimethyl-pentyl, 2-ethylhexyl, octyl, nonyl, decyl, undecyl, dodecyl, tetradecyl, pentadecyl, hexadecyl, heptadecyl, octadecyl, nonadecyl or icosyl.

C₁-C₁₈—, C₁-C₁₂— and C₁-C₄-Alkyl have the same meanings as those described above up to the respective number of carbon atoms.

C₁-C₁₈Alkoxy is, for example, branched or unbranched alkoxy, e.g. methoxy, ethoxy, n-propoxy, isopropoxy, n-butoxy, isobutoxy, sec-butoxy, tert-butoxy, pentyloxy, hexyloxy, heptyloxy, octyloxy, 2,4,4-trimethyl-pent-1-yloxy, 2-ethylhexyloxy, nonyloxy, decyloxy, dodecyloxy or octadecyloxy. C₁-C₁₈—, C₁-C₁₂— and C₁-C₄-Alkoxy have the same meanings as those described above up to the respective number of carbon atoms.

C₁-C₁₂Alkylthio is linear or branched and is, for example, C₁-C₈—, C₁-C₈— or C₁-C₄-alkylthio, e.g. methylthio, ethylthio, n-propylthio, isopropylthio, n-butylthio, isobutylthio, sec-butylthio or tert-butylthio, preferably methylthio.

Substituted phenyl is, for example, mono- to penta-substituted, for example mono-, di- or tri-substituted, on the phenyl ring.

When R₄₀, R₄₁, and R₄₂ are an S- or N-containing 5- or 6-membered heterocyclic ring, they are, for example, thienyl, pyrrolyl or pyridyl.
C₂-C₁₂Alkenyl is linear or branched, can be mono- or poly-unsaturated and is, for example, allyl, methallyl, 1,1-dimethylallyl, 1-butenyl, 2-butenyl, 1,3-pentadienyl, 1-hexenyl or 1-octenyl, especially allyl. C₂-C₄Alkenyl is, for example, allyl, methallyl, 1-butenyl or 2-butenyl.

Halogen is fluorine, chlorine, bromine and iodine, preferably fluorine, chlorine and bromine. The term “polyoxaalkyl” includes C₂-C₂₀alkyl interrupted by from 1 to 9 O atoms and denotes, for example, structural units such as CH₃—O—CH₂—, CH₃CH₂—O—CH₂CH₂—, CH₃O[CH₂CH₂O]₂—, wherein z=1-9, —(CH₂CH₂O)₇CH₂CH₃, —CH₂—CH(CH₃)—O—CH₂—CH₂CH₃.

A divalent aliphatic or aromatic radical Y₁ is, for example, C₁-C₂₀alkylene, linear or branched, uninterrupted or interrupted by one or more O atoms and unsubstituted or substituted by OH; or cycloalkylene, e.g. cyclohexylene, the term cycloalkylene also including radicals such as e.g. —CH₂-cyclohexylene-CH₂—. A corresponding aromatic radical is, for example, phenylene, naphthylene, biphenylene, all unsubstituted or substituted, and all unsubstituted or substituted in a manner analogous to that described for cycloalkyl at the bonds additionally by alkylene.

R₆₀ as substituted 9H-carbazol-3-yl is preferably substituted by C₁-C₁₂alkyl, and —CO)-phenyl or —CO)phenylene-C₁-C₄alkyl, substitution being possible on one of the aromatic rings or at the N atom. R₆₀ is in this case especially a radical of formula

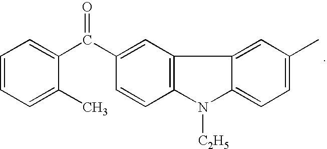

A preferred compound of formula VIII wherein R₆₀ is substituted 9H-carbazol-3yl is

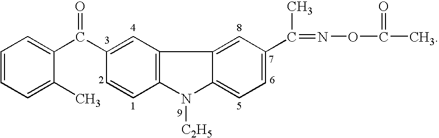

When R₆₈ and R₆₇ together are —S—, the following structure 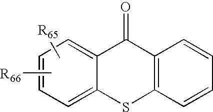
wherein R₆₅ and R₆₆ are as defined is obtained.

G₅ is, for example, O, S or N(CH₃), preferably S or N(CH₃).

Preference is given to compositions wherein
R₃₀ is hydrogen, —OCH₂CH₂—OR₄₇, morpholino, SCH₃, a group

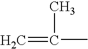

or a group 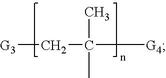
R₃₁, is hydroxy, C₁-C₁₆alkoxy, morpholino or dimethylamino;
R₃₂ and R₃₃ are each independently of the other C₁-C₄alkyl, phenyl, benzyl or C₁-C₁₂alkoxy,
or R₃₂ and R₃₃ together with the carbon atom to which they are bonded form a cyclohexyl ring;
R₄₇ is hydrogen or 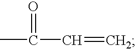
R₃₄, R₃₅ and R₃₆ and R₃₇, R₃₈ and R₃₉ are hydrogen or C₁-C₄alkyl;
R₄₀ is C₁-C₁₂alkyl, unsubstituted phenyl, or phenyl substituted by C₁-C₁₂alkyl or/and C₁-C₁₂alkoxy;
R₄₁, is (CO)R₄₂; and
R₄₂ is phenyl, which is substituted by C₁-C₄alkyl or/and C₁-C₄alkoxy;
R₅₅, R₅₆, R₅₇, R₅₈ and R₅₉ are hydrogen;
   R₅₄ is a group 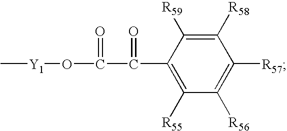
Y₁ is —CH₂CH₂—O—CH₂CH₂—;
x is1;
R₆₀ is phenyl, substituted by SR₆₃ or
R₆₁ is benzoyl;
R₆₂ is hexyl; and
R₆₃ is phenyl.

Preferred compounds of formulae III, IV, V, VI, VII, VIII and IX are α-hydroxycyclohexyl-phenyl-ketone or 2-hydroxy-2-methyl-1-phenyl-propanone, (4-methylthiobenzoyl)-1-methyl-1-morpholino-ethane, (4-morpholino-benzoyl)1-benzyl-1-dimethylamino-propane, (4-morpholino-benzoyl)-1-(4-methylbenzyl)-1-dimethylamino-propane, (3,4-dimethoxy-benzoyl)-1-benzyl-1-dimethylamino-propane, benzil dimethyl ketal, (2,4,6-trimethylbenzoyl)-diphenyl-phosphine oxide, bis(2,6dimethoxybenzoyl)-(2,4,4-trimethyl-pent-1-yl)phosphine oxide, bis(2,4,6-trimethylbenzoyl)-phenyl-phosphine oxide or bis(2,4,6-trimethylbenzoyl)-(2,4-dipentyloxyphenyl)phosphine oxide, 5,5′-oxodi(ethyleneoxydicarbonylphenyl) and dicyclopentadienyl-bis(2,6-difluoro-3-pyrrolo)titanium, and also benzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl-2-benzoyl benzoate, 4-(2-hydroxyethylthio)-benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)-benzophenone, 4-benzoyl-N,N-dimethyl-N-[2-(1-oxo-2-propenyl)oxy]ethyl-benzenemethanaminium chloride; 2,2-dichloro-1-(4-phenoxyphenyl)-ethanone, 4,4′-bis(chloromethyl)-benzophenone, 4-methylbenzophenone, 2-methylbenzophenone, 3-methylbenzophenone, 4-chlorobenzophenone; 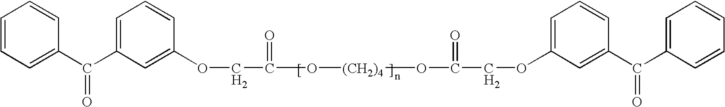
(MFPI-BXP from Coates), 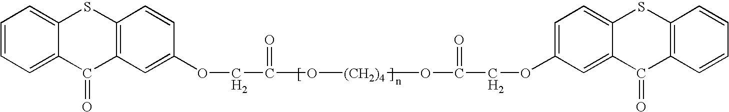
(MFPI-TX from Coates) wherein n has a value of from 2 to 10, 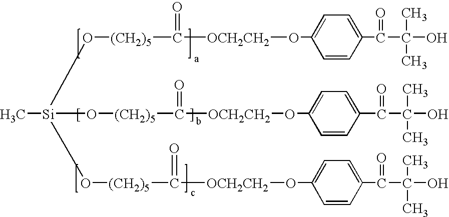
wherein a, b and c are an average of 3 (SiMFP12 from Coates), as described, for example, in WO 01/10872; and also 2-chlorothioxanthone, 2,4-diethylthioxanthone, 2-isopropylthioxanthone, 3-isopropylthioxanthone, 1-chloro-4-propoxythioxanthone.

Also preferred as coinitiators are 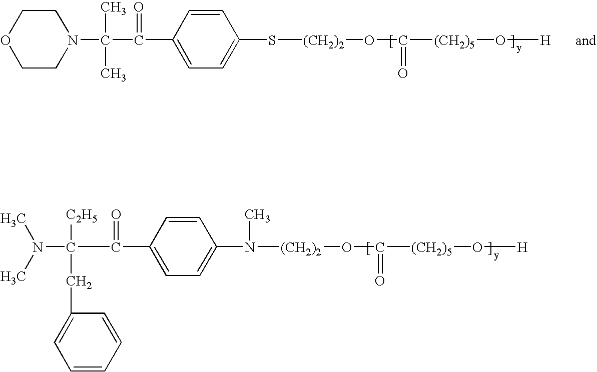
wherein y is from 0 to 10 (Chivacure 3482 and Chivacure 3690 from Chitec Technol.).

Also preferred are compositions wherein in formula III R₃₂ and R₃₃ are each independently of the other C₁-C₆alkyl or together with the carbon atom to which they are bonded form a cyclohexyl ring and R₃₁ is hydroxy.

The proportion of compounds of formula I (=photoinitiator component (b)) in admixture with compounds of formulae III, IV, V, VI, VII, VIII and/or IX (=photoinitiator component (c)) is from 5 to 99%, e.g 20-80%, preferably from 25 to 75%.

Also preferred are compositions comprising compounds of formula I and compounds of formula V wherein
R₄₀ is phenyl unsubstituted or substituted by from one to three C₁-C₁₂alkyl or/and C₁-C₁₂alkoxy substituents, or C₁-C₁₂alkyl;
R₄₁ is the group (CO)R₄₂ or phenyl; and
R₄₂ is phenyl substituted by from one to three C₁-C₄alkyl or C₁-C₄alkoxy substituents.

Of very special interest are compositions as described above that comprise photoinitiator mixtures of formulae I, III, IV, V, VI, VII, VIII and/or IX and are liquid at room temperature.

The preparation of the compounds of formulae III, IV, V, VI, VII, VIII and IX is generally known to the person skilled in the art and some of the compounds are commercially available. The preparation of oligomeric compounds of formula III is described, for example, in EP 161 463. A description of the preparation of compounds of formula IV can be found e.g. in EP 209 831. The preparation of compounds of formula V is disclosed e.g. in EP 7508, EP 184 095 and GB 2 259 704. The preparation of compounds of formula VI is described e.g. in EP 318 894, EP 318 893 and EP 565 488. Compounds of formula VII are known from U.S. Pat. No. 6,048,660 and compounds of formula VIII from GB 2 339 571 or WO 02/100903. Compounds of formula IX can be obtained, for example, analogously to the methods described for the compounds according to the invention. Some of the compounds of formula IX are also commercially available.

The photopolymerisable compositions comprise the photoinitiator advantageously in an amount of from 0.05 to 20% by weight, e.g. from 0.05 to 15% by weight, preferably from 0.1 to 5% by weight, based on the composition. The indicated amount of photoinitiator relates to the sum of all added photoinitiators when mixtures thereof are used, that is to say both to photoinitiator (b) and to photoinitiators (b)+(c).

The photoinitiators of formula I used in the compositions according to the invention and the compounds of formula Ia according to the invention can also be used, for example, in the form of complexes with cyclodextrin, as described, for example, in EP 1 273 638.

The photopolymerisable compositions can be used for a variety of purposes, for example as printing inks, such as screen printing inks, flexographic printing inks and offset printing inks, as UV-curable inks for inkjet printers, as clearcoats, as coloured coats, as whitecoats, for example for wood or metal, as powder coatings, as coating materials inter alia for paper, wood, metal or plastics, as daylight-curable paints for marking structures and roads, for photographic reproduction processes, for holographic recording materials, for image-recording processes or in the production of printing plates that are developable using organic solvents or using aqueous-alkaline media, in the production of masks for screen printing, as dental filling compounds, as adhesives, as pressure-sensitive adhesives, as laminating resins, as photoresists, e.g. galvanoresists, etch resists or permanent resists, both liquid and dry films, as photostructurable dielectrics, and as solder masks for electronic circuits, as resists in the production of colour filters for any type of display screen or in the creation of structures in the production of plasma displays and electroluminescent displays, in the production of optical switches, optical gratings (interference gratings), in the production of three-dimensional articles by bulk curing (UV curing in transparent moulds) or according to the stereolithography process, as described, for example, in U.S. Pat. No. 4,575,330, in the production of composite materials (e.g. styrene polyesters which may include glass fibres and/or other fibres and other adjuvants) and other thick-layered compositions, in the coating or sealing of electronic components or as coatings for optical fibres. The compositions are also suitable for the production of optical lenses, e.g. contact lenses or Fresnel lenses, and also for the production of medical apparatus, aids or implants. The compositions are also suitable for the preparation of gels having thermotropic properties. Such gels are described e.g. in DE 197 00 064 and EP 678 534. The compositions can also be used in dry film paints, as described e.g. in Paint & Coatings Industry, April 1997, 72 or Plastics World, Vol. 54, No. 7, page 48(5).

The compounds of formula I, optionally in combination with further photoinitiators (c), can also be used as initiators for emulsion, bead or suspension polymerisation or as initiators of a polymerisation step for fixing orientation states of liquid-crystalline monomers and oligomers or as initiators for fixing dyes on organic materials.

In surface coatings, use is frequently made of mixtures of a prepolymer with polyunsaturated monomers that also comprise a monounsaturated monomer, the prepolymer in particular determining the properties of the surface-coating film, so that a person skilled in the art will be able to influence the properties of the cured film by varylng the prepolymer. The polyunsaturated monomer functions as a crosslinking agent, which renders the surface-coating film insoluble. The monounsaturated monomer functions as a reactive diluent, by means of which the viscosity is reduced without the need to use a solvent.

Unsaturated polyester resins are generally used in two-component systems together with a monounsaturated monomer, preferably styrene. For photoresists, specific one-component systems are often used, e.g. polymaleinimides, polychalcones or polyimides, as described in DE 2 308 830.

The compounds of formula I and mixtures thereof with further photoinitiators (c) can also be used as free-radical photoinitiators or photoinitiating systems for radiation-curable powder coatings. The powder coatings can be based, for example, on solid resins and monomers containing reactive double bonds, for example maleates, vinyl ethers, acrylates, acrylamides and mixtures thereof. A free-radically UV-curable powder coating can be formulated by mixing unsaturated polyester resins with solid acrylamides (e.g. methacrylamidoglycolate methyl ester) and a free-radical photoinitiator according to the invention, as described, for example, in the presentation “Radiation Curing of Powder Coating”, Conference Proceedings, Radtech Europe 1993 by M. Wittig and Th. Gohmann. Similarly, free-radically UV-curable powder coatings can be formulated by mixing unsaturated polyester resins with solid acrylates, methacrylates or vinyl ethers and a photoinitiator (or photoinitiator mixture) according to the invention. The powder coatings may also comprise binders, as described, for example, in DE 4 228 514 and EP 636 669. The UV-curable powder coatings may also comprise white or coloured pigments. For example, especially rutile/titanium dioxide may be used in concentrations of up to about 50% by weight in order to obtain a cured powder coating having good hiding power. The process normally comprises spraying the powder electrostatically or tribostatically onto the substrate, for example metal or wood, melting the powder by heating and, after a smooth film has formed, radiation-curing the coating with ultraviolet and/or visible light, for example using medium-pressure mercury lamps, metal halide lamps or xenon lamps. A particular advantage of radiation-curable powder coatings over corresponding thermally curable coatings is that the flow time after the powder particles have been melted can be prolonged as desired in order to ensure the formation of a smooth high-gloss coating. Unlike thermally curable systems, radiation-curable powder coatings can be so formulated that they melt at relatively low temperatures without the undesired effect of their useful life being shortened.

For that reason they are also suitable as coatings for heat-sensitive substrates, such as wood or plastics.

In addition to the photoinitiators according to the invention the powder coating formulations may also comprise UV absorbers. Appropriate examples are listed above under points 1 to 8.

The photocurable compositions according to the invention are suitable, for example, as coating materials for all kinds of substrate, for example wood, textiles, paper, ceramics, glass, plastics, such as polyesters, polyethylene terephthalate, polyolefins and cellulose acetate, especially in the form of films, and also metals, such as Al, Cu, Ni, Fe, Zn, Mg or Co and GaAs, Si or SiO₂, to which a protective layer is to be applied or an image is to be applied e.g. by imagewise exposure.

The substrates can be coated by applying a liquid composition, a solution or a suspension to the substrate. The choice of solvent and its concentration are governed chiefly by the nature of the composition and the coating method. The solvent should be inert, that is to say it should not enter into any chemical reaction with the components, and it should be capable of being removed again on drying after the coating operation. Suitable solvents include, for example, ketones, ethers and esters, such as methyl ethyl ketone, isobutyl methyl ketone, cyclopentanone, cyclohexanone, N-methylpyrrolidone, dioxane, tetrahydro-furan, 2-methoxyethanol, 2-ethoxyethanol, 1-methoxy-2-propanol, 1,2-dimethoxyethane, ethyl acetate, n-butyl acetate and ethyl 3-ethoxypropionate.

The formulation is applied uniformly to a substrate by means of known coating methods, for example by spin-coating, immersion, knife coating, curtain pouring, brush application or spraying, including especially e.g. by electrostatic spraying and reverse-roll coating, and also by electrophoretic deposition. It is also possible to apply the photosensitive layer to a temporary flexible support and then to coat the final substrate, e.g. a copper-dad circuit board, by transferring the layer via lamination.

The amount applied (layer thickness) and the nature of the substrate payer support) are dependent upon the desired field of application. The person skilled in the art will be familiar with the layer thicknesses suitable for the fields of use in question, e.g. in the fields of photoresists, printing inks or paints. The range of layer thicknesses generally includes values from about 0.1 μm to more than 10 mm, depending upon the field of use.

The radiation-sensitive compositions can also be used, for example, as negative resists that have a very high degree of photosensitivity and can be developed in an aqueous-alkaline medium without swelling. They are suitable as photoresists for electronics, such as galvanoresists, etch resists, in both liquid and dry films, as solder resists, as resists in the production of colour filters for any type of display screen, or in the formation of structures in the production of plasma displays and electroluminescent displays, in the production of printing plates, such as offset printing plates, in the production of printing blocks for letterpress printing, planographic printing, intaglio printing, flexographic printing or screen printing blocks, the production of relief copies, e.g. for the production of texts in braille, in the production of dies, for use in the etching of mouldings or for use as microresists in the production of integrated circuits. The compositions can also be used as photostructurable dielectrics, for the encapsulation of materials or as insulating coatings in the production of computer chips, printed circuits and other electrical or electronic components. The layer supports that are possible and the conditions for processing the coated substrates are correspondingly various.

The compounds according to the invention are also used in the production of single- or multi-layer materials for image recording or image duplication (copying, reprographics), which may be monochrome or polychrome. Those materials can also be used in colour-testing systems. In that technology it is also possible to use formulations containing micro-capsules, and for creating the image the exposure step can be followed by a thermal step. Such systems and technologies and their use are described e.g. in U.S. Pat. No. 5,376,459.

For photographic information recordings there are used, for example, foils of polyester, cellulose acetate or plastics-coated papers; for offset printing blocks e.g. specially treated aluminium, in the production of printed circuits e.g. copper-clad laminates, and in the production of integrated circuits on silicon wafers. The layer thicknesses customary for photographic materials and offset printing blocks are generally about from 0.5 μm to 10 μm, and for printed circuits from 1.0 μm to about 100 μm.

After the substrates have been coated, the solvent is generally removed by drying, resulting in a layer of photoresist on the support.

The term “imagewise” exposure includes exposure through a photomask having a pre-determined pattern, e.g. a transparency, exposure using a laser beam which is moved over the surface of the coated substrate, for example under computer control, and in that way produces an image, and irradiation with computer-controlled electron beams. It is also possible to use masks of liquid crystals which can be actuated pixel by pixel in order to create digital images, as described e.g. by A. Bertsch, J. Y. Jezequel, J. C. Andre in Journal of Photochemistry and Photobiology A: Chemistry 1997, 107, pp. 275-281 and by K.-P. Nicolay in Offset Printing 1997, 6, pp. 34-37.

Conjugated polymers, e.g. polyanilines, can be converted from a semi-conductive state to a conductive state by doping with protons. The photoinitiators according to the invention can also be used for the imagewise exposure of polymerisable compositions comprising such polymers in order to form conductive structures (in the irradiated zones) which are embedded in insulating material (non-exposed zones). Such materials can be used, for example, as wiring components or connecting components in the production of electrical or electronic components.

After the imagewise exposure of the material and prior to development it may be advantageous to carry out a thermal treatment for a relatively short time. During the thermal treatment only the exposed areas are thermally cured. The temperatures used are generally from 50 to 150° C., preferably from 80 to 130° C.; the duration of the thermal treatment is generally from 0.25 to 10 minutes.

The photocurable composition can also be used in a method of producing printing blocks or photoresists, as described e.g. in DE 4 013 358. In such a method, before, at the same time as or after the imagewise irradiation the composition is, without a mask, exposed briefly to visible light of a wavelength of at least 400 nm. After the exposure and optional thermal treatment, the unexposed areas of the photosensitive coating are removed using a developer in a manner known per-se.

As already mentioned, the compositions according to the invention are developable in an aqueous-alkaline medium. Suitable aqueous-alkaline developer solutions are especially aqueous solutions of tetraalkylammonium hydroxides or of alkali metal silicates, phosphates, hydroxides and carbonates. If desired, relatively small amounts of wetting agents and/or organic solvents can also be added to those solutions. Typical organic solvents that can be added in small amounts to the developer fluids are, for example, cyclohexanone, 2-ethoxyethanol, toluene, acetone and mixtures of such solvents.

Photocuring is of great importance for printing inks, since the drying time of the binder is a determining factor in the rate of production of graphic products and should be of the order of fractions of a second. UV-curable inks are important especially for screen printing, flexographic printing and offset printing, but also for inkjet printing.

As already mentioned above, the mixtures according to the invention are also very suitable for the production of printing plates. For that application there are used, for example, mixtures of soluble linear polyamides or styrene/butadiene or styrene/isoprene rubber, polyacrylates or polymethyl methacrylates having carboxyl groups, polyvinyl alcohols or urethane acrylates with photopolymerisable monomers, for example acrylic or methacrylic amides or acrylic or methacrylic esters, and a photoinitiator. Films and plates made from those systems (wet or dry) are exposed through the negative (or positive) of the original and the uncured portions are then eluted with a suitable solvent.

Another field of use for photocuring is metal coating, for example in the application of a finish to sheets and tubes, cans or bottle closures, as well as photocuring on plastics coatings, for example of PVC-based floor or wall coverings. Examples of the photocuring of paper coatings include the application of a colourless finish to labels, book jackets etc.

Also of interest is the use of the compounds of formula I, optionally in combination with a further photoinitiator (c), in the curing of mouldings made of composite materials. The composite material consists of a self-supporting matrix material, for example woven glass fibres, or alternatively, for example, plant fibres [see K.-P. Mieck, T. Reussmann in Kunststoffe 85 (1995), 366-370], which is impregnated with the photocuring formulation. Mouldings of composite materials so produced achieve a high degree of mechanical stability and resistance. The compounds of formula I can also be used as photohardeners in moulding, impregnating and coating materials, as described, for example, in EP 7086. Such materials are, for example, thin-layer resins, of which high demands are made in terms of curing activity and resistance to yellowing, and fibre-reinforced moulding materials, such as planar or longitudinally or transversely corrugated light panels. Processes for the production of such moulding materials, such as, for example, manual lay-up processes, fibre-spraying, spinning or winding processes, are described, for example, by P. H. Selden in “Glasfaser-verstärkte Kunststoffe”, page 610, Springer Verlag Berlin-Heidelberg-New York 1967. Articles that can be produced, for example, according to that process are boats; chipboard or plywood panels coated on both sides with glass-fibre-reinforced plastics; pipes; sports equipment; roof coverings; containers etc. Further examples of moulding, impregnating and coating materials are UP resin thin layers for glass-fibre containing moulding materials (GRP), for example corrugated panels and paper laminates. Paper laminates may be based on urea or melamine resins. The thin layer is produced on a support (for example a foil) prior to production of the laminate. The photocurable compositions according to the invention may also be used for casting-resins or for the potting of articles, for example electronic components etc. They may also be used for lining cavities and pipes. For curing, medium pressure mercury lamps are used, as are customary in UV curing, but less intense lamps, for example of the TL 40W/03 or TL40W/05 type, are also of particular interest. The intensity of those lamps roughly corresponds to that of sunlight. Direct sunlight can also be used for curing. A further advantage is that the composite material can be removed from the light source in a partially cured, plastic state and subjected to shaping, after which full cure is effected.

The compounds of formula I, optionally in combination with further photoinitiators (c), are also suitable for use in compositions for the coating of glass fibres (optical fibres). Such fibres are usually provided with protective coats immediately after their production. The glass fibre is drawn and then one or more coatings are applied to the glass filament. One, two or three layers are generally applied, the uppermost coating (top coating), for example, being coloured (“ink layer” or “ink coating”). Furthermore, a plurality of fibres so coated are generally assembled Into a bundle and coated, that is to say a glass fibre cable is formed. The compositions of the present Application are generally suitable for all of the above-described coatings of such cables; they need to have good properties in respect of pliability over a wide temperature range, tensile strength, loadability and toughness, and also rapid UV-curing characteristics.

Each of the coats—the inner, first coat, the “primary coating” (usually a pliable, soft coating), the outer first or second coat, the “secondary coating” (usually a firmer coating than the inner coat), the third or cable-forming coat (cabling coat)—may comprise at least one radiation-curable oligomer, at least one radiation-curable monomer and at least one photoinitiator as well as additives.

In general any radiation-curable oligomers are suitable. Preference is given to oligomers having a molecular weight of at least 500, for example from 500 to 10 000, from 700 to 10 000, from 1000 to 8000 or from 1000 to 7000, especially urethane oligomers having at least one unsaturated group. Preferably the radiation-curable oligmer component has two terminal functional groups. The coat may contain a specific oligomer or a mixture of different oligomers. The preparation of suitable oligomers is known to the person skilled in the art and disclosed, for example, in U.S. Pat. No. 6,136,880. The oligomers are obtained, for example, by reaction of an oligomeric diol, preferably a diol having from 2 to 10 polyoxaalkylene groups, with a diisocyanate or a polyisocyanate and a hydroxy-functional ethylenically unsaturated monomer, for example hydroxyalkyl(meth)acrylate. Specific examples of each of those components, as well as suitable quantity ratios of the components, can be found in U.S. Pat. No. 6,136,880.

The addition of the radiation-curable monomer can be used, for example, to control the viscosity of the formulations. Accordingly, there is usually employed a low viscosity monomer having at least one functional group suitable for radiation-curable polymerisation. The amount is, for example, so chosen that a viscosity range of from 1000 to 10 000 mPas is achieved, that is to say usually from 10 to 90% by weight or from 10 to 80% by weight are used. The functional group of the monomer diluent is preferably of the same kind as that of the oligomer component, e.g. an acrylate or vinyl ether function and a higher alkyl or polyether moiety. Examples of monomer diluents suitable as constituents of compositions for coating optical fibres (glass fibres) are published, for example, in U.S. Pat. No. 6,136,880, column 12, line 11 ff.

The first coat, the “primary coating”, preferably comprises monomers having an acrylate or vinyl ether function and a polyether moiety having e.g. from 4 to 20 carbon atoms. Specific examples can be found in the U.S. patent mentioned above.

The composition can also comprise, for example, a poly(siloxane), as described in U.S. Pat. No. 5,595,820, in order to improve the adhesive properties of the formulation to the glass fibre.

The coating compositions usually comprise further additives in order to prevent discoloration of the coating, especially during the production process, and to improve the stability of the cured coat. Examples are antioxidants, light stabilisers, UV absorbers, for example as described above, especially ®IRGANOX 1035, 1010, 1076, 1222, ®TINUVIN P, 234, 320, 326, 327, 328, 329, 213, 292, 144, 622LD (all Ciba Spezialitätenchemie), ®ANTIGENE P, 3C, FR, GA-80, ®SUMISORB TM-061 (Sumitomo Chemical Industries Co.), ®SEESORB 102, 103, 501, 202, 712, 704 (Sypro Chemical Co., Ltd.), ®SANOL LS770 (Sankyo Co. Ltd.). Particularly interesting are stabiliser combinations of sterically hindered piperidine derivatives (HALS) and sterically hindered phenol compounds, e.g. a combination of IRGANOX 1035 and TINUVIN 292, for example in a ratio of 1:1. Further additives are, for example, wetting agents or other additives having an effect on the rheological properties of the coating. Amines, e.g. diethylamine, can also be added.

Other examples of additives that can be used in compositions for the coating of optical fibres are silane crosslinking agents, e.g. γ-aminopropyltriethoxysilane, γ-mercaptopropyltrimethoxysilane, γ-methacryloxypropyl-trimethoxysilane, SH6062, SH6030 (Toray-Dow Corning Silicone Co., Ltd.), KBE 903, KBE 603, KBE 403 (Shin-Etsu Chemical Co., Ltd.).

In order to prevent discoloration of the coatings it is also possible for e.g. fluorescent additives or optical brighteners, e.g. ®UVITEX OB, from Ciba Spezialitätenchemie, to be added to the compositions.

For use in coatings for optical fibres, the compounds of formula I, as already mentioned above, can be used in admixture with one or more other photoinitiators, especially with mono- or bis-acylphosphine oxides, e.g. diphenyl-2,4,6-trimethylbenzoylphosphine oxide, bis(2,4,6-trimethylbenzoyl)phenylphosphine oxide (®IRGACURE 819), bis(2,6-dimethoxybenzoyl)-2,4,-trimethylpentylphosphine oxide; α-hydroxyketones, e.g. 1-hydroxycyclohexylphenyl ketone (®IRGACURE 184), 2-hydroxy-2-methyl-1-phenyl-1-propanone (®DAROCUR 1173), 2-hydroxy-1-[4-2-hydroxyethoxy)phenyl]-2-methyl-1-propanone (®IRGACURE 2959); α-aminoketones, e.g. 2-methyl-1-[4-(methylthio)phenyl]-2-(4-morpholinyl)-1-propanone (®IRGACURE 907); 2-benzyl-2-(dimethylamino)-1-[4-(4-morpholinyl)phenyl]-1-butanone (®IRGACURE 369); benzophenones, e.g. benzophenone, 2,4,6-trimethylbenzophenone, 4-methylbenzophenone, 2-methylbenzophenone, 2-methoxycarbonylbenzophenone, 4,4′-bis(chloromethyl)benzophenone, 4-chlorobenzophenone, 4-phenylbenzophenone, 4,4′-bis(dimethylamino)benzophenone, 4,4′-bis(diethylamino)benzophenone, methyl 2-benzoyl benzoate, 3,3′-dimethylmethoxybenzophenone, 4-(4-methylphenylthio)benzophenone and also ketal compounds, e.g. 2,2-dimethoxy-1,2-diphenyl-ethanone (®IRGACURE 651); monomeric or dimeric phenylglyoxylic acid esters, e.g. methylphenylglyoxylic acid ester, 5,5′-oxo-di(ethyleneoxydicarbonylphenyl) (®IRGACURE 754) or 1,2-(benzoylcarboxy)ethane. Especially suitable are mixtures with mono- or bis-acylphosphine oxides and/or α-hydroxyketones.

It will be evident that in order to enhance the properties of the photoinitiators the formulations may also comprise sensitiser compounds, e.g. amines.

The coatings are usually applied either “wet on dry” or “wet on wet”. In the first case, after the application of the first coating (primary coat) a curing step by irradiation with UV light is carried out before the second layer is applied. In the second case, the two coatings are applied and cured together by means of irradiation with UV light.

For this application, the curing with UV light is usually carried out in a nitrogen atmosphere. In general all radiation sources customarily used in photocuring technology can also be used for curing the coatings of the optical fibres, that is to say, for example, radiation sources as described hereinbelow. Usually mercury medium-pressure lamps or/and Fusion D lamps are used. Flash lamps are also suitable. It will be dear that the emission spectrum of the lamps has to be matched to the absorption spectrum of the photoinitiator or photoinitiator mixture used. The compositions for coating optical fibres can likewise be cured by irradiation with electron beams, especially with low-energy electron beams, for example as described in WO 98/41484.

In order to be able to differentiate between the different fibres in an arrangement of several fibres, the fibres can be provided, for example, with a third, coloured coat (“ink coating”). The compositions used for such coatings comprise, in addition to the polymerisable components and the photoinitiator, a pigment or/and a dye. Examples of pigments suitable in such coatings are inorganic pigments, e.g. titanium dioxide, zinc oxide, zinc sulfide, barium sulfate, aluminium silicate, calcium silicate, carbon, black iron oxide, black copper chromite, iron oxides, green chromium oxides, iron blue, chromium green, violet (e.g. manganese violet, cobalt phosphate, CoLiPO₄), lead chromates, lead molybdates, cadmium titanates and pearlescent and metallic pigments, and also organic pigments, e.g. monoazo pigments, diazo pigments, diazo condensation pigments, quinacridone pigments, dioxazine violet, vat dyes, perylene pigments, thioindigo pigments, phthalocyanine pigments and tetrachlorolsoindolinones. Examples of suitable pigments are carbon for black coatings, titanium dioxide for white coatings, diarylide yellow or pigments based on diazo compounds for yellow coatings, phthalocyanine blue and other phthalocyanines for blue coatings, anthraquinone red, naphthol red, pigments based on monoazo compounds, quinacridone pigments, anthraquinone and perylenes for red coatings, phthalocyanine green and pigments based on nitroso compounds for green coatings, pigments based on monoazo and diazo compounds, quinacridone pigments, anthraquinones and perylenes for orange coatings, and quinacridone violet, basic dye pigments and pigments based on carbazole dioxazine for violet coatings. The person skilled in the art will be familiar with the formulation and mixing of any further suitable pigments and dyes for the purpose of obtaining further coloured coatings, for example light-blue, brown, grey, pink etc. The average particle size of the pigments is usually about 1 μm or less. If necessary, the size of commercially available pigments can be reduced, for example by milling. The pigments can be added to the formulations in the form of a dispersion, for example, in order to facilitate mixing with the other constituents of the formulation. The pigments are dissolved, for example, in a low-viscosity liquid, e.g. a reactive diluent. It is usually preferred to use organic pigments. The proportion of pigments in a coloured coating is, for example, from 1 to 20% by weight, from 1 to 15% by weight, preferably from 1 to 10% by weight

The coloured coating generally also comprises a lubricant in order to improve the properties in respect of break-out of the individual coated fibres from the matrix. Examples of such lubricants are silicones, fluorohydrocarbon oils or resins etc.; especially silicone oils or functionalised silicone compounds, e.g. silicone diacrylate, are used.

The compositions of the present Application are also suitable as matrix material for an arrangement of coated optical fibres. That is to say, different fibres provided with a first, second (and in some cases a third, optionally coloured) coat are brought together in a matrix. The coating for such an arrangement of different coated optical fibres (assembly) usually comprises, in addition to the additives already described above, a release agent In order to ensure access to the individual fibres, for example during installation of the cables. Examples of such release agents are Teflon, silicones, silicone acrylates, fluorohydrocarbon oils and resins etc. Such additives are usually used in amounts of from 0.5 to 20% by weight. Examples of coloured coatings (ink coatings) and matrix materials for coated optical fibres can be found e.g. in U.S. Pat. Nos. 6,197,422 and 6,130,980 and in EP 614 099.

The compositions according to the invention can also be used in the production of light waveguides and optical switches, where the generation of a difference in refractive index between exposed and non-exposed regions is utilised.

Also important is the use of photocurable compositions for imaging processes and for the optical production of information carriers. For that application, as already described above, the layer (wet or dry) applied to the support is irradiated with UV or visible light through a photomask and the unexposed areas of the layer are removed by treatment with a solvent (=developer). The photocurable layer can also be applied to metal in an electrodeposition process. The exposed areas are crosslinked-polymeric and are therefore insoluble and remain on the support. When suitably coloured, visible images are formed. When the support is a metallised layer, after exposure and development the metal can be etched away in the unexposed areas or strengthened by electroplating. In this way it is possible to produce printed electronic circuits and photoresists.

The benzophenone photoinitiators used in the compositions according to the invention are also suitable for use in a method for improving the adhesion of coatings as described, for example, in WO 03/064061. In such a method, after a plasma or corona treatment step or a flame-treatment step on the substrate to which the firmly adherent coating is to be applied, the compounds are fixed on the surface as photoinitiators, optionally in combination with monomers, oligomers and further photoinitiators, for example by irradiation with UV light.

The photoinitiators, or mixtures of the initiators with monomers, oligomers and further photoinitiators, applied to the surface of the substrate after the plasma or corona treatment step or a flame-treatment step are preferably used in solutions, that is to say also in a suitable solvent.

The photosensitivity of the compositions according to the invention usually extends from approximately 200 nm to approximately 600 nm (UV range). Suitable radiation is present, for example, in sunlight or light from artificial light sources. Accordingly a large number of the most varied kinds of light source may be used. Both point sources and planiform radiators (lamp arrays) are suitable. Examples are: carbon arc lamps, xenon arc lamps, medium-pressure, high-pressure and low-pressure mercury radiators, doped, where appropriate, with metal halides (metal halide lamps), microwave-excited metal vapour lamps, excimer lamps, superactinic fluorescent tubes, fluorescent lamps, argon incandescent lamps, flash lamps, photographic floodlight lamps, light-emitting diodes (LED), electron beams and X-rays. The distance between the lamp and the substrate according to the invention being exposed may vary according to the intended use and the type and strength of the lamp and may be, for example, from 2 cm to 150 cm. Especially suitable are laser light sources, for example excimer lasers, such as Krypton-F lasers, for example, for exposure at 248 nm. Lasers in the visible range may also be used. According to this method

It is possible to produce printed circuits in the electronics industry, lithographic offset printing plates or relief printing plates and also photographic image-recording materials.

The invention therefore relates also to a process for the photopolymerisation of non-volatile monomeric, oligomeric or polymeric compounds having at least one ethylenically unsaturated double bond, wherein a composition as described above is irradiated with light in a range of from 200 to 600 nm. The invention also relates to the use of the compounds of formula I as photoinitiators for the photopolymerisation of non-volatile monomeric, oligomeric or polymeric compounds having at least one ethylenically unsaturated double bond by irradiation with light in a range of from 200 to 600 nm.

The invention relates also to the use of a composition as described above and a process for the production of pigmented and non-pigmented surface coatings, printing inks, e.g. screen-printing inks, offset printing inks, UV-curable inks for inkjet printers, flexographic printing inks, powder coatings, printing plates, adhesives, dental compounds, light waveguides, optical switches, colour-testing systems, composite materials, glass fibre cable coatings, screen-printing stencils, resist materials, colour filters, its use for encapsulating electrical and electronic components, in the production of magnetic recording materials, in the production of three-dimensional articles by means of stereolithography, for photographic reproductions, and its use as image-recording material, especially for holographic recordings, for decolorising materials, for decolorising materials for image-recording materials, for image-recording materials using microcapsules.

The invention relates likewise to a coated substrate that has been coated on at least one surface with a composition as described above, and to a process for the photographic production of relief images in which a coated substrate is irradiated imagewise and the unexposed areas are then removed with a solvent. The imagewise exposure can be carried out through a mask or by means of a laser beam, exposure using a laser beam being of special interest.

The benzophenone compounds of formula I in the compositions according to the invention are reactive, have good solubility properties in the monomers, oligomers and polymers customarily used in conventional photocurable formulations and exhibit good yellowing and odour properties.

The following Examples further illustrate the invention. In the Examples, as in the remainder of the description and in the patent claims, unless otherwise indicated parts and percentages relate to weight. Where alkyl or alkoxy radicals having more than three carbon atoms are mentioned without any reference to their isomeric form, the data relate to the respective n-isomers.

### EXAMPLE 1

### Preparation of 3-methyl-4′-phenylbenzophenone (=biphenyl-4-yl-3-tolyl-methanone)

46.3 g (0.30 mol) of biphenyl and 150 g of 1,2-dichlorobenzene are introduced into a flask having a condenser and a dropping funnel. 46.0 g (0.345 mol) of aluminium chloride are added and the mixture is cooled to 5 to 0° C. 48.7 g (0.315 mol) of 3-toluyl chloride are then added dropwise thereto over a period of one hour at from 5 to 0° C. HCl gas is evolved. The dark-yellow solution is then stirred overnight at an internal temperature of 5-0° C. The reaction mixture is then poured into ice and water and stirred to complete the reaction. The two phases are separated in a separating funnel. The organic phase is washed twice with water and then concentrated in vacuo. The last solvent residues are removed under a high vacuum. The light-yellow oil is dissolved in hexane while hot and left to crystailise. The product forms white crystals which are filtered off and dried in vacuo. The melting point is 81.8-83.2° C. The purity of the product is confirmed by thin-layer chromatography and the ¹H-NMR spectrum.

### EXAMPLE 2

### Preparation of 2,4,6-trimethyl-4′-phenylbenzophenone (=biphenyl-4-yl-(2,4,6-trimethylphenyl)-methanone)

The title product having a melting point of 111-112° C. is obtained analogously to the method described in Example 1 using the appropriate starting materials.

### EXAMPLE 3

### Preparation of an Overprint Varnish

A photocurable formulation is prepared by mixing together the following components:
32.0 parts epoxy acrylate, diluted with 25% tripropylene glycol diacrylate (TPGDA) (Ebecryl 605, UCB)
56.0 parts tripropylene glycol diacrylate
5.0 parts p-dimethylaminobenzoic acid ethyl ester (EPD)
6.0 parts of the benzophenone photoinitiator in question (according to Examples 1 and 2)
1.0 part silicone acrylate (wetting agent and lubricant, Ebecryl 1360)

The coating is applied to white cardboard using a 6 μm knife and then cured. Curing is effected by passing the sample on a conveyor belt moving at a defined speed [m/min] under two 120 W/cm mercury lamps (IST-Metz GmbH). The belt speed necessary to obtain a wipe-resistant surface is determined. The higher the belt speed, the more reactive is the photoinitiator in the formulation. The cured formulation is wipe-resistant when a wiping test using a paper towel leaves no traces on the surface of the coating.

At a belt speed of 90 m/min both the formulation with the benzophenone according to Example 1 and the formulation with the compound according to Example 2 are cured so that they are wipe-resistant.

### EXAMPLE 4

For determining the solubility properties in acrylate monomers, which are customarily used for the preparation of overprint varnishes and UV-curable inks, 0.2 g each of the compounds obtained according to Examples 1 and 2 is stirred into 2.5 g of the acrylate monomer in question. In dipropylene glycol diacrylate (DPGDA) both compounds have dissolved within a period of 15 minutes at room temperature. In ethoxylated trimethylolpropane triacrylate (TMP(3EO)TA) the compound according to Example 2 dissolves within a period of 10 minutes at 40° C., while the compound according to Example 1 dissolves after only 4 minutes' heating at 40° C.

### EXAMPLE 5

A photocurable formulation is prepared by mixing together the following components:

| | | |
|---|---|---|
| 79.5 | parts | polyester hexaacrylate (Ebecryl 830) |
| 20.0 | parts | hexanediol diacrylate |
| 0.5 | part | flow improver (Byk 300) |
| 100.0 | parts | |

3% of the compound of Example 1 and 3% N-methyldiethanolamine are incorporated into the resulting formulation.

The formulation is applied to a coil-coated aluminium sheet using a 6 μm knife and then cured. Curing is effected by passing the sample on a conveyor belt moving at a defined speed under two 80 W/cm medium-pressure mercury lamps. The maximum belt speed at which the coating is cured is determined. The higher that speed of the conveyor belt, the more effective is the initiator used. In the present case, curing takes place at a belt speed of 50 m/min.

### EXAMPLE 6

A photocurable formulation as described in Example 5, containing 3% of the compound of Example 1 and 3% N-methyldiethanolamine as photoinitiator, is applied using a 100 μm slotted knife to a chipboard panel that has been coated with a white primer and is then cured. The curing is effected by passing the sample on a conveyor belt moving at a speed of 5 m/min under two 80 W/cm medium-pressure mercury lamps. Thereafter the pendulum hardness according to König (DIN 53157) is determined in [s]. The pendulum hardness is a measure of the extent to which the composition has hardened. The higher those values, the more effectively has the curing taken place. In the present case, a pendulum hardness of 165 s is achieved.

1. A photocurable composition comprising:
(a) at least one ethylenically unsaturated photopolymerisable compound and
(b) as photoinitiator at least one compound of formula I 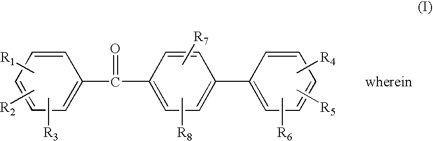
R₁, R₂ and R₃ are each independently of the others hydrogen or C₁-C₄alkyl, cyclopentyl or cyclohexyl;
R₄, R₅ and R₆ are each independently of the others hydrogen, C₁-C₄alkyl, cyclopentyl or cyclohexyl; and
R₇ and R₈ are each independently of the other hydrogen, C₁-C₄alkyl, cyclopentyl or cyclohexyl;
with the provisos that
(i) at least one radical R₁, R₂, R₃, R₄, R₅, R₆, R₇, R₈ is other than hydrogen;
(ii) when all radicals R₄, R₅, R₆, R₇ and R₈ are hydrogen and only one radical R₁, R₂, R₃ is C₁-C₄alkyl, that radical must be in the meta-position of the phenyl ring; and
(iii) when all radicals R₁, R₂, R₃, R₇ and R₈ are hydrogen and two of the radicals R₄, R₅ and R₆ are hydrogen and the remaining radical R₄, R₅ or R₆ is C₁-C₄alkyl, that alkyl radical is not bonded in the para-position on the phenyl ring.

2. A photocurable composition according to claim 1 wherein in a compound of formula (I)
R₁, R₂ and R₃ are each independently of the others C₁-C₄alkyl; and
R₄, R₅, R₆, R₇ and R₈ are hydrogen.

3. A photocurable composition according to claim 1 wherein in a compound of formula (I)
R₁ is methyl and is bonded in the 3-position of the phenyl ring; and
R₂, R₃, R₄, R₅, R₆, R₇ and R₈ are hydrogen; or
R₁, R₂ and R₃ are methyl and are bonded in the 2-, 4- and 6-positions of the phenyl ring; and
R₄, R₅, R₆, R₇ and R₈ are hydrogen.

4. A photocurable composition according to claim 1, comprising in addition to components (a) and (b) further photoinitiators (c) and/or further additives (d).

5. A photocurable composition according to claim 4 wherein the additional photoiniators (c) are compounds of formulae III, IV, V, VI, VII, VIII or/and IX 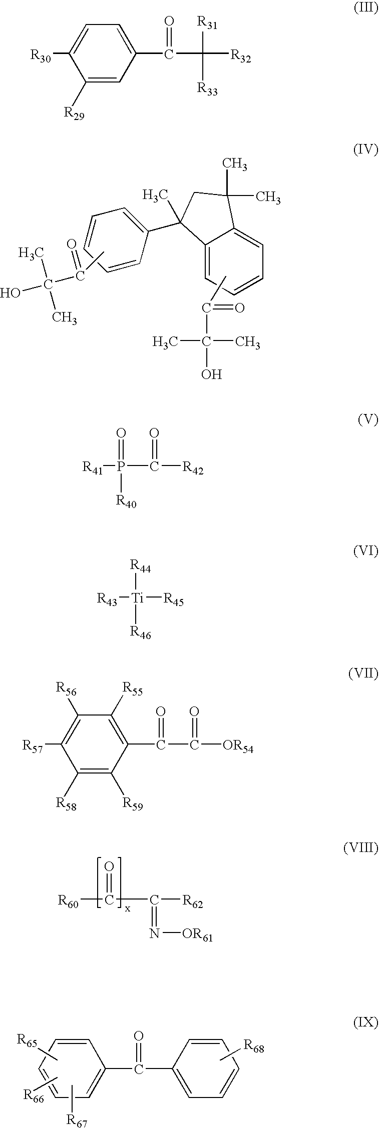
wherein
R₂₉ is hydrogen or C₁-C₁₈alkoxy;
R₃₀ is hydrogen, C₁-C₁₈alkyl, C₁-C₁₈alkoxy, —OCH₂CH₂—OR₄₇, morpholino, SCH₃, a group 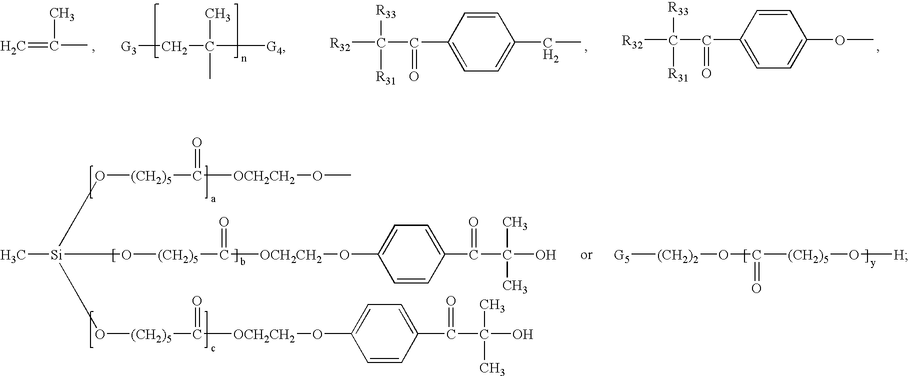
a, b and c are an average of 3;
n has a value from 2 to 10;
y is from 0 to 10;
G₃ and G₄ are each independently of the other terminal groups of the polymeric unit;
R₃₁ is hydroxy, C₁-C₁₆alkoxy, morpholino, dimethylamino or —O(CH₂CH₂O)ₘ—C₁-C₁₆alkyl;
R₃₂ and R₃₃ are each independently of the other hydrogen, C₁-C₆alkyl, C₁-C₁₆alkoxy or -O(CH₂CH₂O)m-C₁-C,₆alkyl; or R₃₂ and R₃₃ are phenyl or benzyl, those radicals being unsubstituted or substituted by C₁-C₁₂alkyl; or R₃₂ and R₃₃ together with the carbon atom to which they are bonded form a cyclohexyl ring;
m is a number from 1 to 20;
but R₃₁, R₃₂ and R₃₃ are not all simultaneously C₁-C₁₆alkoxy or —O(CH₂CH₂O)ₘ—C₁-C₁₆alkyl;
R₄₇ is hydrogen, 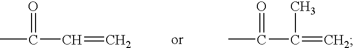
R_{34,} R₃₆, R₃₇ and R₃₈ are each independently of the others hydrogen or methyl;
R₃₅ and R₃₉ are hydrogen, methyl or phenylthio, the phenyl ring of the phenylthio radical being unsubstituted or substituted in the 4-, 2-, 2,4- or 2,4,6-position(s) by C₁-C₄alkyl;
R₄₀ and R₄₁, are each independently of the other C₁-C₂₀alkyl, cyclohexyl, cyclopentyl, phenyl, naphthyl or biphenylyl, those radicals being unsubstituted or substituted by halogen, C₁-C₁₂alkyl, C₁-C₁₂alkoxy, C₁-C₁₂alkylthio or NR₅₂R₅₃, or R₄₀ and R₄, are a S- or N-containing 5- or 6-membered heterocyclic ring or —(CO)R₄₂;
R₄₂ is cyclohexyl, cyclopentyl, phenyl, naphthyl or biphenylyl, those radicals being unsubstituted or substituted by halogen, C₁-C₄alkyl or/and C₁-C₄alkoxy, or R₄₂ is a S- or N-containing 5- or 6-membered heterocyclic ring;
R₄₃ and R₄₄ are each independently of the other cyclopentadienyl unsubstituted or mono-, di- or tri-substituted by C₁-C₁₈alkyl, C₁-C₁₈alkoxy, cyclopentyl, cyclohexyl or halogen;
R₄₅ and R₄₆ are each independently of the other phenyl which is substituted by fluorine atoms or CF₃ in at least one of the two positions ortho to the titanium-carbon bond and which may contain, as further substituents on the aromatic ring, polyoxaalkyl; or pyrrolinyl unsubstituted or substituted by one or two C₁-C₁₂alkyl, di(C₁-C₁₂alkyl)aminomethyl, morpholinomethyl, C₂-C₄alkenyl, methoxymethyl, ethoxymethyl, trimethylsilyl, formyl, methoxy or phenyl substituents, or R₄₅and R₄₆ are 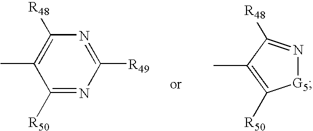
R₄₈, R₄₉, and R₅₀ are each independently of the others hydrogen, halogen, C₂-C₁₂alkenyl, C₁-C₁₂alkoxy, C₂-C₁₂alkoxy interrupted by from one to four O atoms, cyclohexyloxy, cyclopentyloxy, phenoxy, benzyloxy, or phenyl or biphenylyl each unsubstituted or substituted by C₁-C₄alkoxy, halogen, phenylthio or C₁-C₄alkylthio,
wherein R₄₈ and R₅₀ are not both simultaneously hydrogen and in the radical 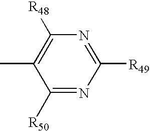
least one radical R₄₈ or R₅₀ is C_{1-C}₁₂alkoxy, C₂-C₁₂alkoxy interrupted by from one to four O atoms, cyclohexyloxy, cyclopentyloxy, phenoxy or benzyloxy;
G₅ is O, S or NR₅₁; and
R₅₁ is C₁-C₈alkyl, phenyl or cyclohexyl;
R₅₂ and R₅₃ are each independently of the other hydrogen; C₁-C₁₂alkyl which is uninterrupted or interrupted by O atoms and which is unsubstituted or substituted by OH or SH; or R₅₂ and R₅₃ are C₂-C₁₂alkenyl, cyclopentyl, cyclohexyl, benzyl, or phenyl;
R₅₄ is hydrogen, C₁-C₁₂alkyl or a group 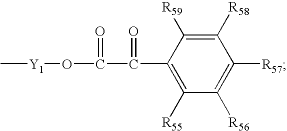
R₅₅, R₅₆, R₅₇, R₅₈ and R₅₉ are each independently of the others hydrogen; C₁-C₁₂alkyl, which is unsubstituted or substituted by OH, C₁-C₄alkoxy, phenyl, naphthyl, halogen or CN and which may be uninterrupted or interrupted by one or more O atoms; or R₅₅, R₅₆, R₅₇, R₅₈ and R₅₉ are C₁-C₄alkoxy, C₁-C₄alkylthio or NR₅₂R₅₃;
Y₁ is a divalent aliphatic or aromatic radical;
x is 0 or 1;
R₆₀ is phenyl, naphthyl, or, when x is 0, 9H-carbazol-3-yl, or (9-oxo-9H-thioxanthen-2-yl), all those radicals being unsubstituted or substituted by one or more SR₆₃, OR₆₄, NR₅₂R₅₃, halogen, C₁-C₁₂alkyl, phenyl, benzyl, —(CO)—C₁-C₄alkyl, —(CO)-phenyl or —(CO)-phenylene-C₁-C₄alkyl substituents;
R₆₁ is C₄-C₉cycloalkanoyl; C₁-C₁₂alkanoyl unsubstituted or substituted by one or more halogen, phenyl or CN substituents; or R₆₁, is C₄-C₆alkenoyl, with the proviso that the double bond is not conjugated with the carbonyl group; or R₆₁ is benzoyl unsubstituted or substituted by one or more C₁-C₆alkyl, halogen, CN, OR₆₄, SR₆₃ or NR₅₂R₅₃ substituents; or R₆, is C₂-C₆alkoxycarbonyl, benzyloxycarbonyl; or phenoxycarbonyl unsubstituted or substituted by one or more C₁-C₆alkyl or halogen substituents;
R₆₂ is hydrogen, phenyl or benzoyl, the radicals phenyl or benzoyl being unsubstituted or substituted by C₁-C₆alkyl, phenyl, halogen, OR₆₄, SR₆₃ or NR₅₂R₅₃; or R₆₂ is C₁-C₂₀alkyl or C₂-C₁₂alkoxycarbonyl, the radicals C₁-C₂₀alkyl and C₂-C₁₂alkoxycarbonyl being unsubstituted or substituted by OH and uninterrupted or interrupted by one or more O atoms; or R₆₂ is C₂-C₂₀alkanoyl, benzyl, benzyl-(CO)—, C₁-C₆alkyl-SO₂— or phenyl-SO₂—;
R₆₃ and R₆₄ are each independently of the other hydrogen or C₁-C₁₂alkyl unsubstituted or substituted by OH, SH, CN, phenyl, (CO)O—C₁-C₄alkyl, O(CO)—C₁-C₄alkyl, COOH, or O(CO)-phenyl, it being possible for such unsubstituted or substituted C₁-C₁₂alkyl to be interrupted by one or more O atoms; or R₆₃ and R₆₄ are cyclohexyl, or phenyl unsubstituted or substituted by C₁-C₁₂alkyl, C₁-C₁₂alkoxy or halogen, or phenyl-C₁-C₃alkyl;
R₆₅, R₆₆ and R₆₇ are each independently of the others hydrogen, C₁-C₄alkyl, C₁-C₄haloalkyl, C₁-C₄alkoxy, chlorine or N(C₁-C₄alkyl)₂; or, for the case where R₆₇ and R₆₈ together are S, R₆₅ may also be 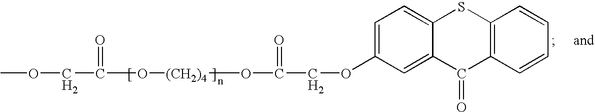
R₆₈ is hydrogen, C₁-C₄alkyl, C₁-C₄haloalkyl, phenyl, N(C₁-C₄alkyl)₂, COOCH₃, 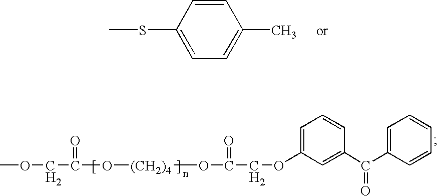
or R₆₈ and R₆₇ together are —S—.

6. A photocurable composition according to claim 4, comprising the photoinitiator (b) or photoinitiators (b)+(c) in an amount of from 0.05 to 20% by weight, based on the composition.

7. A compound of formula Ia 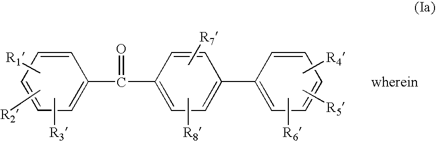
R₁′, R₂′ and R₃′ are each independently of the others hydrogen or C₂-C₄alkyl, cyclopentyl or cyclohexyl;
R₄′, R₅′ and R₆′ are each independently of the others hydrogen, C₂-C₄alkyl, cyclopentyl or cyclohexyl; and
R₇′ and R₈′ are each independently of the other hydrogen, C₂-C₄alkyl, cyclopentyl or cyclohexyl;
with the provisos that
(iv) at least one radical R₁′, R₂′, R₃′, R₄′, R₅′, R₆′, R₇′, R₈′ is other than hydrogen; and
(v) p-tert-butylphenyl-biphenylyl ketone is excluded.

8. (canceled)

9. A method for the photopolymerisation of monomeric, oligomeric or polymeric compounds having at least one ethylenically unsaturated double bond, wherein a composition according to claim 1 is irradiated with light in a range of from 200 to 600 nm.

10. (canceled)

11. A method according to claim 9 for the production of pigmented and non-pigmented surface coatings, printing inks, screen-printing inks, offset printing inks, UV-curable inks for inkjet printers, flexographic printing inks, powder coatings, printing plates, adhesives, dental compounds, light waveguides, optical switches, colour-testing systems, composite materials, glass fibre cable coatings, screen-printing stencils, resist materials, colour filters, gelcoats (thin layers), for encapsulating electrical and electronic components, for the production of magnetic recording materials, three-dimensional articles by means of stereolithography, photographic reproductions, image-recording material, especially for holographic recordings, form the production of decolorising materials or for the production of image-recording materials using microcapsules.

12. A coated substrate which has been coated on at least one surface with a composition according to claim 1.

13. A method for the photographic production of relief images in which a coated substrate according to claim 12 is irradiated imagewise and the unexposed portions are then removed with a solvent.
